(19) United States
(12) Patent Application Publication
(10) Pub. No.: US 2014/0365107 A1
(43) Pub. Date: Dec. 11, 2014

(54) Specifying Travel Times for Calendared Events

(71) Applicant: Apple Inc., Cupertino, CA (US)

(72) Inventors: Lala Dutta, Wake Forest, NC (US); Jeffrey Harris, Berkeley, CA (US)

(73) Assignee: Apple Inc., Cupertino, CA (US)

(21) Appl. No.: 14/081,945

(22) Filed: Nov. 15, 2013

Related U.S. Application Data
(60) Provisional application No. 61/832,848, filed on Jun. 8, 2013.

(51) Int. Cl. G01C 21/00

(52) U.S. Cl. CPC G01C 21/00
USPC 701/408; 701/533; 701/538; 701/400; 701/527

(57) ABSTRACT

Some embodiments provide a calendar application for associating travel times with appointments in a calendar. For an appointment in a calendar, the calendar application creates a representation of the travel time to display in the calendar layout. The calendar application provides a travel time tool to create the travel time representation for an appointment. The travel time representation is an item in the calendar UI just like an appointment is an item in the calendar UI. The travel time item represents the estimated time required to travel between a particular location and the location of the appointment.

### CLAIM OF BENEFIT TO PRIOR APPLICATIONS

This application claims the benefit of U.S. Provisional Patent Application 61/832,848, filed Jun. 8, 2013, which is incorporated herein by reference.

### BACKGROUND

Many electronic devices today provide calendar applications that allow their users to organize their appointments in an electronic calendar. A calendar provides a visual representation of one or more periods of time, such as years, months, weeks, days and hours. It is also common to refer to a collection of appointments as a calendar. For example, a user may have a first calendar that contains personal appointments and a second separate calendar that contains work appointments. The appointments from the user's “calendars” may then be displayed on a calendar. In order to avoid confusion, in this document, the visual display of calendars will be referred to as calendar layouts. Collections of user appointments will be referred to as appointment collections or calendars.

Many calendar applications allow the users to view their appointments according to different temporal layouts, such as a monthly layout, a weekly layout, a daily layout, etc. In other words, a calendar application can provide a user with several different views of the same period of time. Each of these views, or layouts, provides a different level of detail for different ranges of time. A calendar layout displays a particular period of time along multiple dimensions or axes. Many calendar layouts are defined along two axes, where each axis specifies a different range of temporal values. A calendar application can provide different ranges of temporal values along each axis for different types of calendar layouts. For example, many calendar applications provide a daily view, a weekly view, and a monthly view. The daily view may provide a single day along the horizontal axis and the hours of the day along the vertical axis. Similarly, the weekly view may provide five or seven days of the week along the horizontal axis and the hours of the day along the vertical axis. The monthly view may provide days of the week (i.e., Sunday through Saturday) along the horizontal axis and weeks of the month along the vertical axis.

Commonly, in calendars displayed on electronic devices, a user's appointments, and meetings can be specified in a calendar layout at the intersection of different temporal values along the different axes. The location of an appointment item within the layout identifies the times and/or dates associated with the appointment.

While calendar applications are highly useful for organizing appointments, they do suffer a few shortcomings. For instance, current calendar applications do not provide a convenient method for accounting for travel times related to an appointment. Current applications often require a user to account for the travel time for an event by adding a reminder to the event. Such implementations require a user to determine the travel time necessary for an event and to manually add the travel time to a reminder.

### BRIEF SUMMARY

Some embodiments of the invention provide a calendar application for associating travel times with appointments in a calendar. For an appointment that has been specified in a calendar, the calendar application of some embodiments creates, or allows a user to create, a representation of the travel time to display in the calendar layout. In some embodiments, the calendar application provides a travel time tool to create the travel time representation for an appointment. The travel time tool can be a menu item, keyboard shortcut, selectable user interface (UI) item, or some other alternative form of user input to specify the travel time. Alternatively or conjunctively, the travel time tool in some embodiments is a selectable item in an application preference setting that directs the application to automatically specify the travel time for an appointment based on the preference settings. In some embodiments, the travel time tool (1) can statically allow the user to specify the travel time by entering it or selecting it from a set of one or more travel times, and/or (2) can dynamically compute the travel time based on the location of the calendared event, another location and a mode of transportation, as further described below.

In some embodiments, the travel time representation blocks off time in a user's schedule, allowing a user of the application to see where new appointments may conflict with the time required to travel to an existing appointment. In some embodiments, the travel time representation indicates to other users that the particular user is busy during the travel time, when the particular user's calendar is made available to other users in a calendaring system. When other users view the particular user's calendar to schedule appointments or to check availability, the particular user will be shown as unavailable during a travel time to or from an appointment, because of the travel time representation.

In some embodiments, the travel time representation is an item in the calendar UI just like an appointment is an item in the calendar UI. Like an appointment item, the travel time item can block other appointments on the calendar or it can be shown to collide with appointment and travel time items that overlap with it. Also, in some embodiments, a user can edit a travel time item (e.g., to adjust its duration) just as the user can edit an appointment item.

In some embodiments, the travel time item represents the estimated time required to travel between a particular location and the location of the appointment. Accordingly, to generate the travel time representation, the calendar application in some embodiments calculates a route from a start location to a location of an appointment based on a method of travel, and then computes the time that it takes to travel this route. Alternatively, or conjunctively, the travel time item in some embodiments represents the estimated time required to travel between the location of the appointment and a destination location. To generate the travel time representation for traveling to such a destination location, the calendar application of some embodiments calculates a route from the location of the appointment to the destination location based on a method of travel, and then computes the time that it takes to travel this route. In some embodiments, the calculated travel time accounts for other variables, such as traffic, weather, etc. Also, in some embodiments, the calendar application dynamically adjusts travel times for an appointment based on different sets of data.

In order to compute the travel time between the location of the appointment and a start or destination location, the calendar application has to know or estimate the start or destination location. When the start or destination location is not known, some embodiments provide a method for identifying a user's start or destination location based on certain heuristics. Also, for situations when the mode of travel is not known, some embodiments provide a method for identifying the mode of travel (i.e., the mode of transportation) based on user preferences, travel distances, or other information.

The preceding Summary is intended to serve as a brief introduction to some embodiments as described herein. It is not meant to be an introduction or overview of all subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawings, but rather are to be defined by the appended claims, because the claimed subject matters can be embodied in other specific forms without departing from the spirit of the subject matters.

### BRIEF DESCRIPTION OF THE DRAWINGS

The novel features as described here are set forth in the appended claims. However, for purposes of explanation, several embodiments are set forth in the following figures.

FIG. 1 illustrates an example of a daily calendar layout.

FIG. 2 illustrates an example of a weekly calendar layout.

FIG. 3 illustrates an example of a monthly calendar layout.

FIG. 4 illustrates adding a travel time to an appointment in a calendar.

FIG. 5 illustrates adding a travel time before and after an appointment.

FIG. 6 illustrates a weekly view of a calendar with a driving travel time.

FIG. 7 illustrates a weekly view of a calendar with a walking travel time.

FIG. 8 illustrates an example of selecting a mode of transportation for computing a travel time associated with an appointment.

FIGS. 9a-b illustrate creating an appointment and adding a travel time to the appointment.

FIG. 10 illustrates setting a custom travel time for an appointment.

FIG. 11 illustrates providing a set of travel times calculated for different modes of transportation.

FIG. 12 illustrates displaying an extended section of appointment information to remind a user to modify certain appointment settings.

FIG. 13 conceptually illustrates a process of some embodiments for calculating a travel time for an appointment.

FIG. 14 illustrates an example of setting a location for an appointment.

FIG. 15 conceptually illustrates a process of some embodiments for determining a start location for a travel time calculation.

FIG. 16 illustrates an example of using heuristics to determine a start location for an appointment and generating a travel time from the start location.

FIG. 17 illustrates another example of using heuristics based on the time of day to determine a start location for an appointment.

FIG. 18 conceptually illustrates a process for selecting a method of travel for a travel time for an appointment.

FIG. 19 illustrates an example of determining a method of travel for a travel time to/from an appointment.

FIG. 20 illustrates another example of determining a method of travel for a travel time to/from an appointment.

FIG. 21 illustrates displaying a map and directions for a calculated route to an appointment.

FIG. 22 illustrates displaying a map with a route for a day's itinerary.

FIG. 23 illustrates providing a standard notification to a user about a scheduled appointment.

FIG. 24 illustrates providing a novel notification to a user for a scheduled appointment, where the notification accounts for travel time.

FIG. 25 conceptually illustrates a process for updating travel time based on changes in data related to the travel time.

FIG. 26 illustrates an example of dynamically changing the travel time for an appointment based on changes to other appointments.

FIG. 27 illustrates an example of dynamically changing the travel time for an appointment based on a detected change in location.

FIG. 28 illustrates an example of dynamically updating the travel time for an appointment based on traffic data.

FIG. 29 conceptually illustrates example architecture of a calendar application that manages travel time items for appointments in a calendar application.

FIG. 30 is an example of an architecture of a mobile computing device.

FIG. 31 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a calendar application for associating travel times with appointments in a calendar. In some embodiments, the application allows a user to add travel time to an appointment that is calendared and displayed in a layout of the calendar. In some embodiments, the travel time is represented as a travel time item in the graphical user interface (GUI) of the calendar.

In some embodiments, the calendar application provides a travel time tool to create the travel time item for an appointment. The travel time tool can be a menu item, keyboard shortcut, selectable user interface (UI) item, or some other alternative form of user input to specify the travel time. Alternatively or conjunctively, the travel time tool in some embodiments is a selectable item in an application preference setting that directs the application to automatically specify the travel time for an appointment based on the preference settings. In some embodiments, the travel time tool (1) can statically allow the user to specify the travel time by entering it or selecting it from a set of one or more travel times, and/or (2) can dynamically compute the travel time based on the location of the calendared event, another location and a mode of transportation, as further described below.

In some embodiments, the travel time item blocks off time in a user's schedule, allowing a user of the application to see where new appointments may conflict with the time required to travel to an existing appointment. In some embodiments, the travel time item indicates to other users that the particular user is busy during the travel time, when the particular user's calendar is made available to other users in a calendaring system. When other users view the particular user's calendar to schedule appointments or to check availability, the particular user will be shown as unavailable during a travel time to or from an appointment, because of the travel time item. Like an appointment item, the travel time item in some embodiments can block other appointments on the calendar or it can be shown to collide with appointment and travel time items that overlap with it.

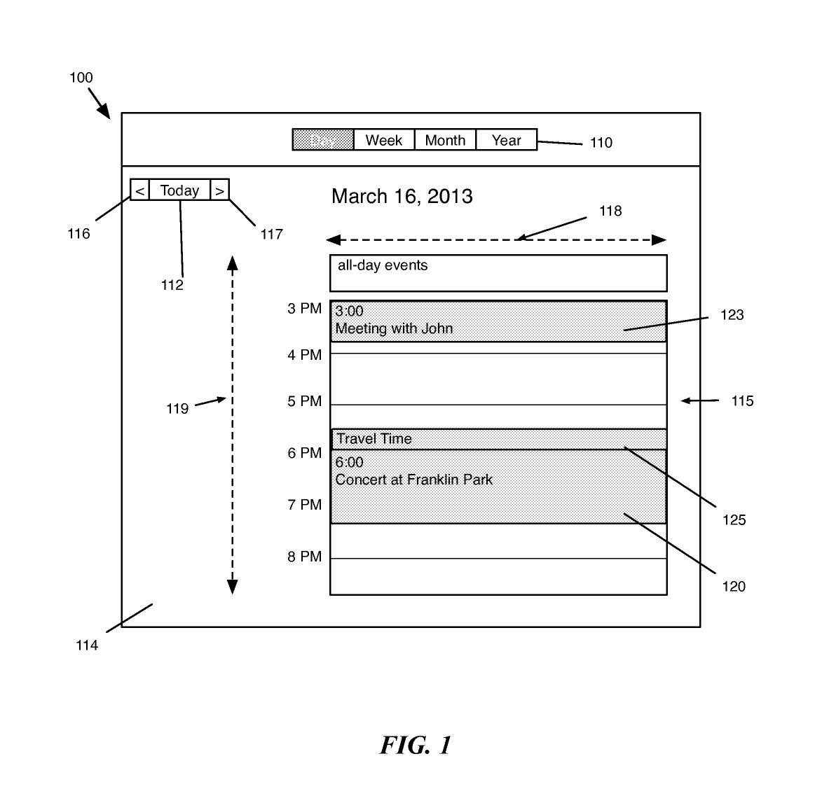

For a calendar application that manages appointments and notifications for the appointments, some embodiments of the invention provide, in various calendar layouts, a novel representation of a travel time associated with an appointment. Examples of travel time items in various layouts will now be described by reference to FIGS. 1-3.

FIG. 1 illustrates a GUI 100 of a calendar application of some embodiments that creates a travel time representation for a calendared event and displays this travel time representation next to the appointment in a calendar layout. As shown in this figure, the GUI 100 includes a calendar view selector 110, a date selector 112, and a calendar display area 114.

The calendar display area 114 displays a calendar layout with various appointment collections. In this example, the calendar display area is displaying a daily layout 115 that shows a single day across the horizontal axis (x-axis) 118 and the hours between 3 pm and 9 pm on the vertical axis 119. In this daily layout, the single day is presented as a table with one column that spans across several time values along the y-axis 119, and several rows that span along x-axis 118. The column is between two values along the x-axis 118, while each rows is defined between two time values along the y-axis 119. In some embodiments, the user can scroll along the y-axis to see a different time range, and can adjust the layout to show a greater time range than 6 hours. The axes 118 and 119 are depicted in this figure for illustrative purposes and the calendar display area 114 does not actually display these axes.

The calendar view selector 110 is a user interface (UI) tool for selecting among different calendar views (i.e., different calendar layouts) to be displayed in the calendar display area 114. The highlighted “Day” in this selector indicates that the current view of the calendar in the calendar display area 114 is the daily calendar layout 115. Selecting Week, Month, or Year in the calendar view selector 110 would change the view of the calendar in the calendar display area to a weekly view, a monthly view, or a yearly view respectively.

The date selector 112 is a UI tool for selecting a date or a range of dates to be displayed in the calendar display area 114. In this example, the current selected date is Today, so the calendar display area 114 shows the appointments for the current day. Arrows 116 and 117 are UI tools to select another date. Various UI tools may be used as a date selector. In some embodiments, a miniature monthly calendar is used as a date selector, and selection of a date or a range of dates in this miniature calendar updates the calendar layout displayed in the calendar display area 114 to show that date or the range of dates.

In the example illustrated in FIG. 1, the daily calendar layout 100 includes (1) two appointment items 120 and 123 that represent two appointments in the calendar and (2) a travel time item 125 that represents the travel time for the appointment item 120. Each of the items 120, 123 and 125 is a rectangular cell that is placed in the calendar layout to represent an event in the calendar. Each of these items 120, 123 and 125 span along the x-axis 118 and are between two time values along the y-axis. For instance, the starting time for the appointment item 120 is indicated by a time value (i.e., 6:00 PM) aligned with a top edge of the item 120 along the vertical axis (y-axis) 119. The ending time for the appointment item 120 is indicated by a time value (i.e., 7:30 PM) aligned with the bottom edge of the item 120 along the vertical axis 119.

The travel time item 125 is shown aligned with a fifteen minute period of time before the appointment item 120 to indicate the amount of time necessary to travel to the location of this appointment. Like the appointment item 120, the travel time item 125 spans the entire column that represents the day. In this example, the travel time item 125 has been added to the daily layout automatically by the calendar application after the appointment item 120 is added to the layout.

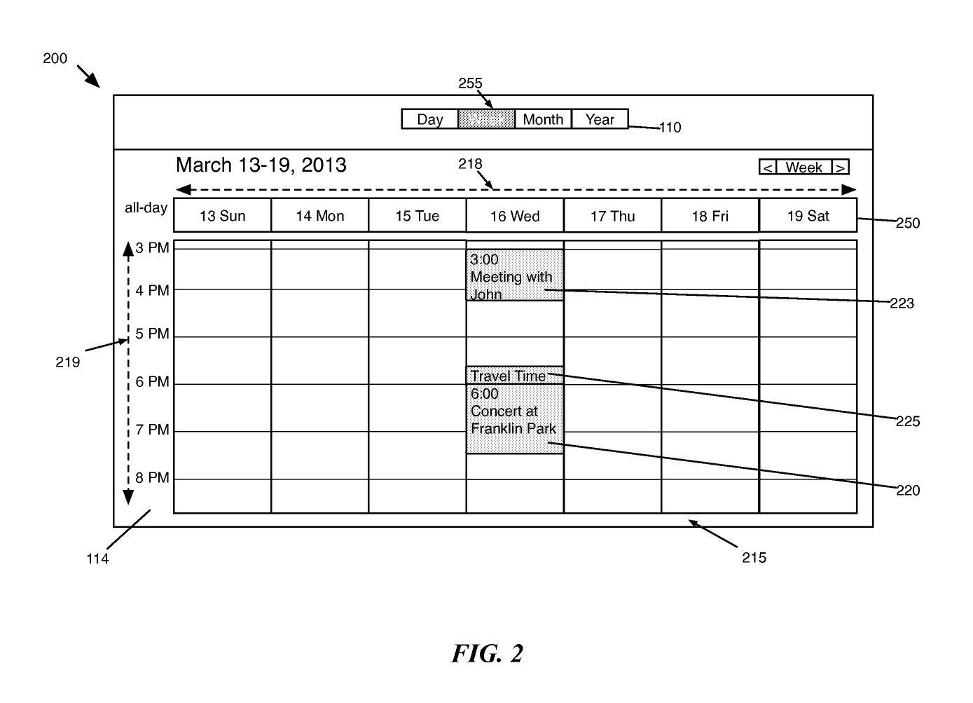

The travel time item 125 can be shown in multiple different calendar layouts of the calendar application. FIG. 2 illustrates the calendar of FIG. 1 after the weekly view has been selected in the calendar view selector 110. The selector 110 represents this selection through the highlighting of the Week option 255. Like the daily calendar layout 115 of FIG. 1, the weekly calendar layout 215 presents hours of the day along the vertical axis 219. However, unlike the daily calendar layout 115, the weekly calendar layout 215 shows seven columns for the seven days of the week along the horizontal axis 218. Above each column, the day for that column is specified in a header row 250.

In the weekly view, the travel time item 225 is displayed in a similar manner as the daily view described in FIG. 1. Appointment items 220 and 223 and travel time item 225 are aligned with the appropriate day along the horizontal axis 218. They are also aligned based on the times for the appointments and the travel time along the vertical axis 219. In other words, each appointment or travel time item falls between two temporal values that specify the start and end times for the item.

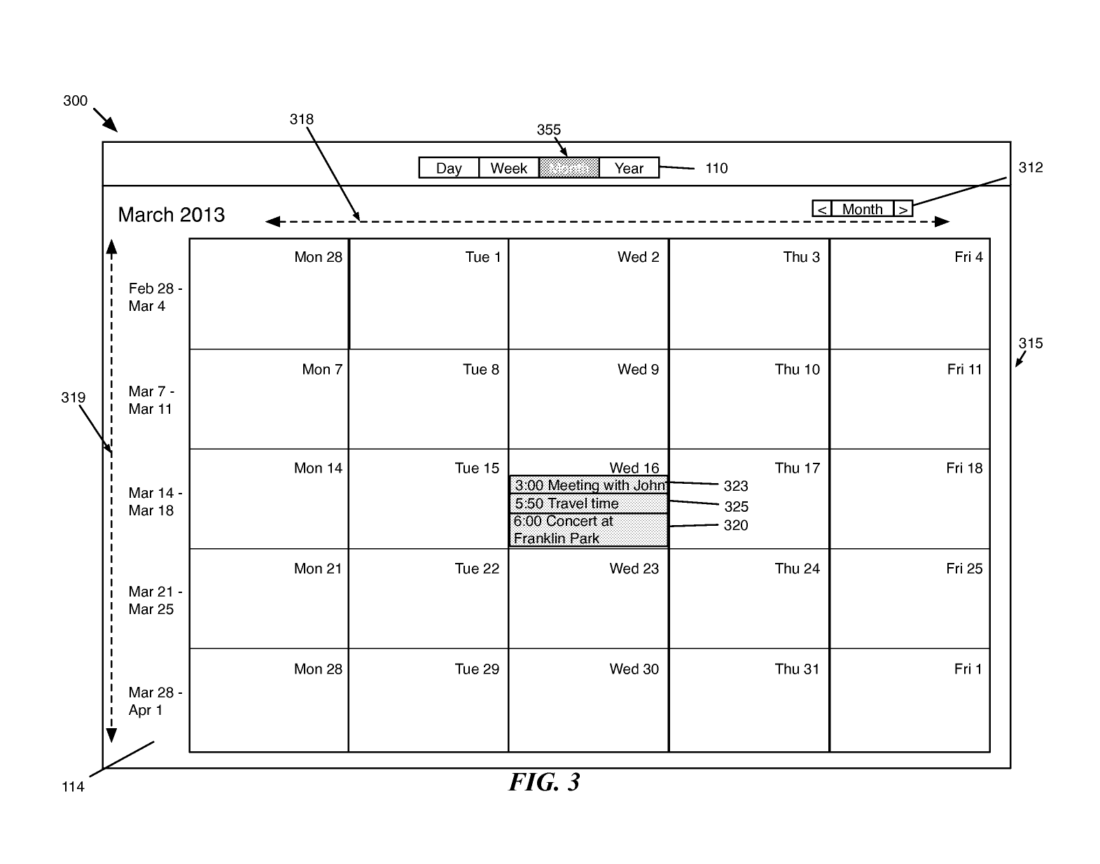

FIG. 3 illustrates the calendar of FIG. 1 after the monthly calendar layout 315 has been selected in the calendar view selector 110. The selector 110 represents this selection through the highlighting of the Month option 355. In monthly calendar layout 315, the layout presents a calendar month. Like the weekly calendar layout 215 of FIG. 2, the monthly calendar layout 315 displays the days of the week as cells that are placed along the horizontal axis 318. In this example, the monthly calendar layout only displays the weekdays (i.e., Monday through Friday) along the horizontal axis 318. The date for each day is written in the cell for the day. Unlike the weekly calendar layout 215 that shows the hours of the day along the y-axis, the monthly calendar layout 315 shows the weeks of the month along the vertical axis 319.

Like the daily and weekly calendar layouts 115 and 215, the monthly calendar layout 315 includes both appointment and travel time items in the layout's display. In each day's cell, the appointment and travel time items for that day are presented in a list. For instance, the appointment items 320 and 323 and travel time item 325 for Wednesday, March 16, are presented in a list in this day's cell. Instead of representing the travel time for a particular appointment as an item in the day's cell, some embodiments simply augment the representation of the particular appointment in the day's cell in order to reduce the number of items to list in each day's cell in the monthly calendar layout. For instance, an appointment may begins at 6:00 PM, but the calendar may show the appointment's start time as 5:40 PM to account for a 20 minute travel time. Alternatively or conjunctively, in some embodiments, the travel time item may be represented with an indication (e.g., an icon or a badge) on the appointment item 320; the selection of this indication displays the travel time for an appointment.

Several more detailed examples are provided below to further illustrate the displaying, calculating, applying and updating of the travel times. Section I further describes displaying travel time items in calendar layouts. Section II then describes how some embodiments allow a user to specify travel times. Section III next describes how some embodiments calculate travel times. Section IV describes calendar applications that display maps to show the relationship between the different locations of calendared appointments. Section V then describes updating the travel times and routes based on different information. Section VI then describes example electronic systems that implement some embodiments of the invention. The section headers below are meant only to organize some of the discussion below. They are not meant to restrict the discussion in any one section to just the embodiments described in that section. All of the discussion that is described in one section is equally applicable to the embodiments described in the other sections.

Many of the examples below explain several embodiments in terms of daily and weekly views of the calendar. However, one of ordinary skill in the art will realize that other layouts (e.g., monthly, yearly, etc.) could be employed by other embodiments, such as the monthly view illustrated in FIG. 3.

### I. Displaying Travel Time Items

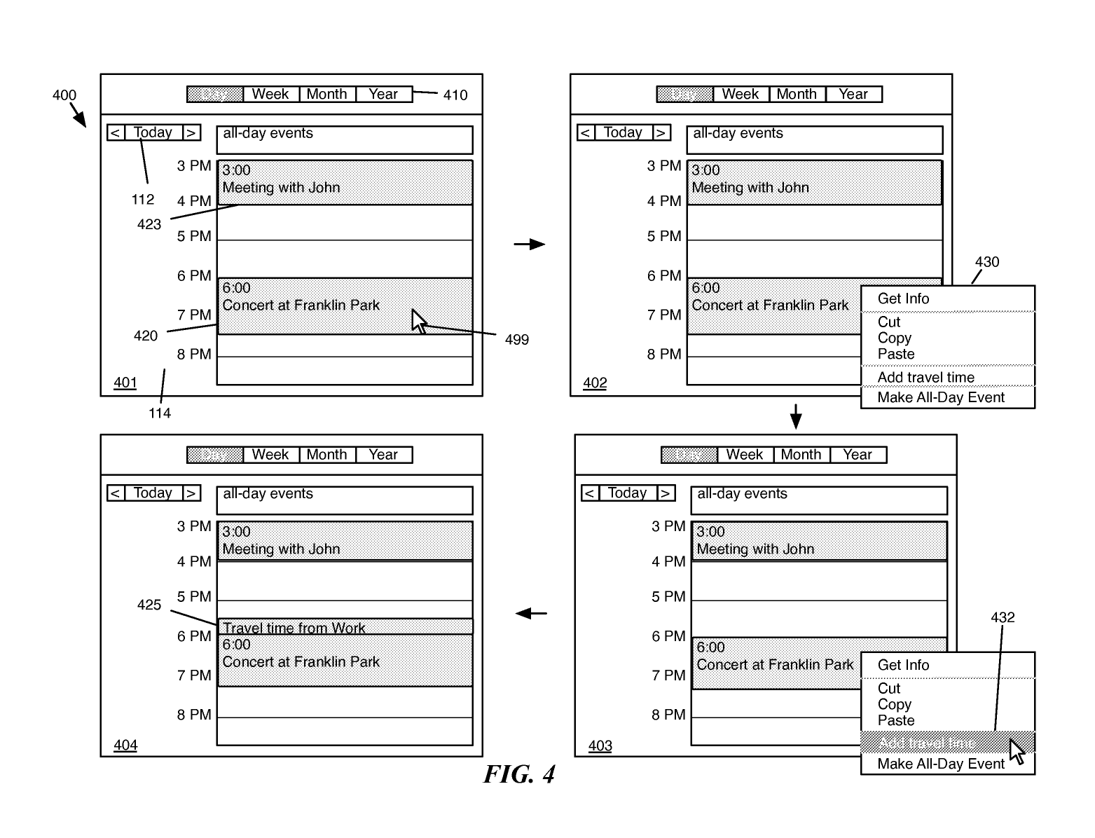

FIG. 4 illustrates an example of how some embodiments add travel time to a calendared appointment. As described above, a travel time for an appointment is an estimation of the time required to travel either to or from a location associated with the appointment. In the example illustrated in FIG. 4, added travel time accounts for a time that it takes to reach the location of a calendared appointment. This example is illustrated in four operational stages 401-404 of a GUI 400 of a calendar application. Like the GUI 100 of FIG. 1, the GUI 400 shows the calendar view selector 110, the date selector 112, the calendar display area 114, and appointment items 420 and 423.

In the first stage 401, a user selects the appointment item 420 and directs the calendar application to present a contextual menu associated with this item 420. In some embodiments, the user can perform different operations to invoke the presentation of the contextual menu. For instance, in some embodiments, the user positions a location indicator (e.g., a cursor 499) over the item 420 and performs a clicking operation. This click operation can be a right-finger click operation, a control-click operation, a left-finger click operation, or a double click operation. Alternatively, the contextual menu can be invoked through other operations, such as a touch screen operation, hot key operation, etc. Also, some embodiments do not require selection of an appointment item to bring up a contextual menu, but rather use a keyboard shortcut, a menu item, or other method to bring up the contextual menu.

The second stage 402 illustrates the presentation of a contextual menu 430 over the selected appointment item 420 in response to the selection of appointment item 420 in the previous stage 401. The contextual menu 430 has several options from which to choose, such as Get Info for getting information about the appointment, Cut for cutting or removing the appointment from the calendar layout, Copy for copying the appointment, Add travel time for adding travel time, and Make All-Day Event for making the appointment an all-day event, as illustrated in FIG. 4. The contextual menu of other embodiments may have more or fewer options.

The third stage 403 shows the “Add travel time” option 432 selected in the contextual menu 430. In this example, this option has been selected by placing the location indicator over the option 432 and selecting the option 432 (e.g., performing a click operation). This option could also be selected through other mechanisms (e.g., touching) in some embodiments.

As shown in the fourth stage 404, the selection of the “Add travel time” option 432 adds a travel time item 425 prior to the appointment item 420 in the calendar layout. The travel time item 425 is displayed as a separate item, and represents the time it takes to travel to the location of appointment item 420. In this example, the appointment item 420 represents a concert at Franklin Park, and the travel time item 425 represents the travel time from the user's work (i.e., the user's work address) to Franklin Park.

In some embodiments, the calendar application picks a pre-specified duration or receives a user-specified duration for the travel time and its associated item 425. However, in other embodiments, the calendar application computes the travel time based on the location of the appointment item 420, the location of an event before the appointment item 420, and a mode of transportation used by the user. In some embodiments, the calendar application identifies the location of the appointment from the data that was entered when the appointment item 420 was made (e.g., by the user that entered the data or by the calendar application when the user accepted an invitation to the appointment with the specified address).

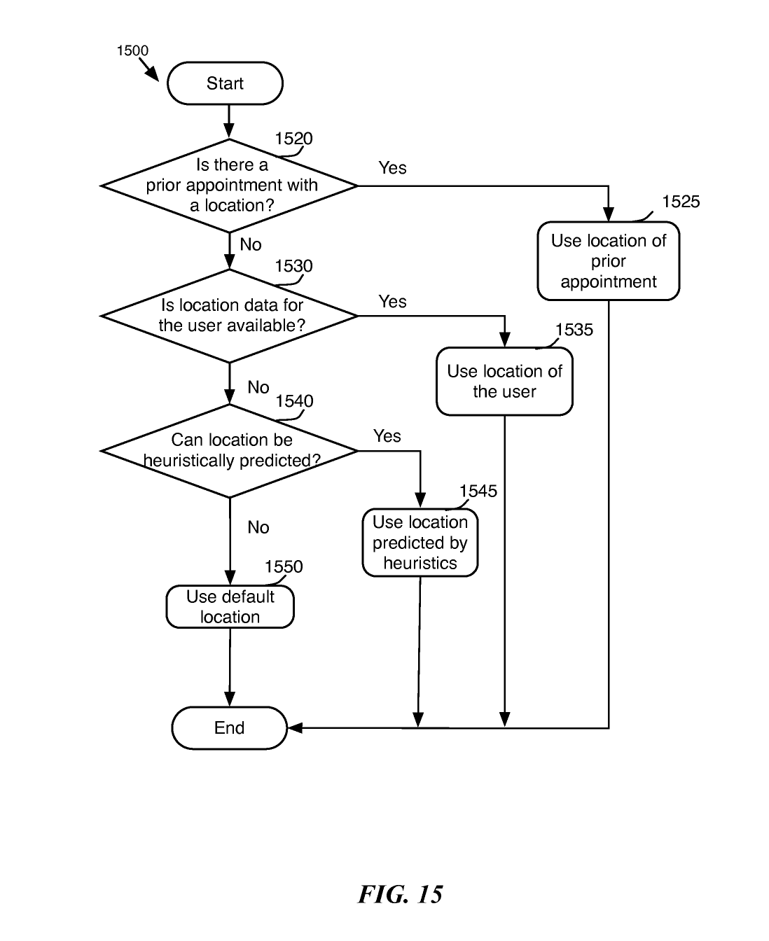

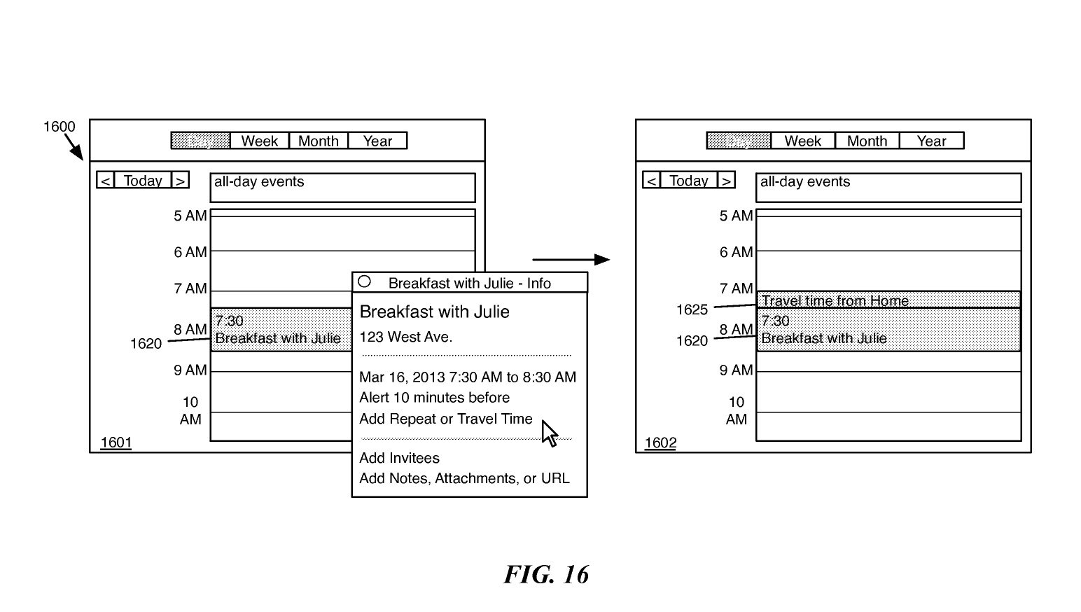

In some embodiments, when the location of a previous event is not known, the calendar application picks the location of the user's work as the previous destination based on heuristics that the application gathers. Some of the heuristics are described in detail further below by reference to FIGS. 15-16.

After identifying the location of the appointment item 420 and the location from which the user travels to the location of the appointment item 420, the calendar application computes the travel time based on these two locations and the user's expected mode of transportation. In some embodiments, the calendar application also factors other data (e.g., current or historic traffic data) to compute the travel time. Several examples below further describe how the calendar application of some embodiments (1) allows a user to enter a location of an appointment, (2) uses heuristics to predict the location of the prior appointment when the application has not received the location of the prior appointment, and (3) computes the travel time.

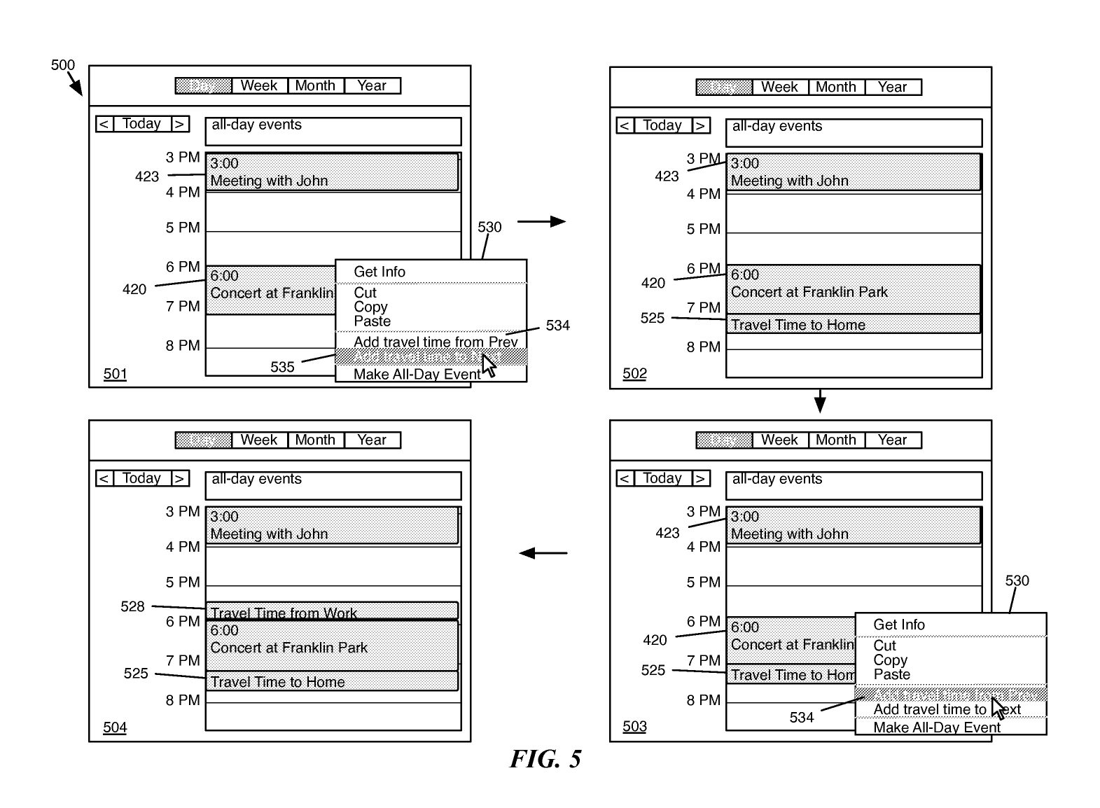

The examples described thus far by reference to FIGS. 1-4 all show a travel time item that represents the travel time to reach the location for an event. However, some embodiments not only account for travel time to the location of an appointment, but also account for travel time from the location of an appointment. FIG. 5 illustrates an example of adding travel time before and after an appointment. This example illustrates a calendar application GUI 500 that is identical to the calendar application GUI 400 of FIG. 4, except that the GUI 500's contextual menu 530 has two options for adding travel time. An option 534 adds travel time before an appointment, while the other option 535 adds travel time after the appointment.

For the same two appointments 420 and 423 on the same day as in the example of FIG. 4, FIG. 5 shows in four stages 501-504 the addition of travel time before and after appointment 420. The first stage 501 shows the contextual menu 530 of the calendar GUI 500. Rather than the single option 432 to “Add travel time” shown in FIG. 4, the contextual menu 530 includes an “Add travel time from Previous” option 534 and an “Add travel time to Next” option 535. The option 534 is for adding the travel time from a location prior to the appointment to the location of the appointment. The option 535 is for adding the travel time from the location of the appointment to a location after the appointment. The first stage 501 shows that the “Add travel time to Next” option 535 has been selected.

The second stage 502 illustrates that the calendar application has added a travel time item 525 after the appointment item 420 in response to the selection of the “Add travel time to Next” option 535. In this example, rather than adding a travel time from a location to the location of the appointment (i.e., from the user's work to Franklin Park), the calendar application adds a time from the appointment's location to a different location (e.g., from Franklin Park to the user's home).

The third stage 503 then shows the re-invocation of the contextual menu 530 for the appointment 420. This stage also shows the selection of the “Add travel time from Previous” option 534 in the contextual menu 530. The fourth stage 504 illustrates that the calendar application adds a second travel time item 525 for the appointment item 420 before this item 420 in response to the selection of the “Add travel time to Previous” option 534. This second travel time item 525 represents the travel time from the user's work to the location of the appointment.

In the examples illustrated by FIGS. 1-5, the calendar application of some embodiments specifies travel times before or after an appointment to account for travel to or from the location of the appointment. Many of the examples below account for travel times before appointments. However, one of ordinary skill in the art will realize that many of the embodiments illustrated in the examples below are equally applicable to accounting for travel times after appointments. Also, in many of the examples described above and below, travel times are added to appointments through the selection of “Add Travel Time” options or commands in contextual menus. However, one of ordinary skill will realize that travel time items can be added for appointments in a calendar layout through other menu items, keyboard shortcuts, or other user input. Alternatively or conjunctively, travel times may be also added automatically based on user preferences.

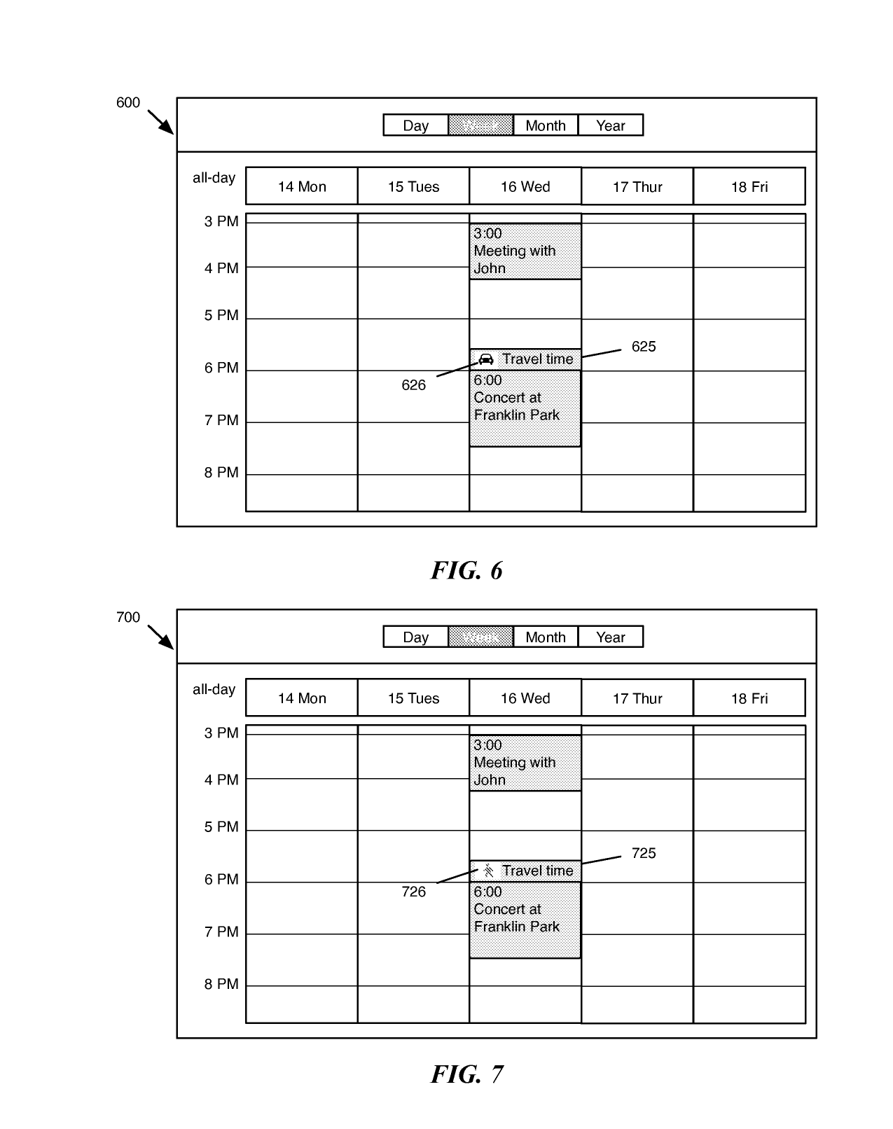

In some embodiments, the calendar application specifies travel time to or from the location an event based on the mode of transportation that the user might be using to come to or leave from the location. For instance, the calendar application specifies driving travel time or walking travel time to or from an event. To differentiate driving travel time from walking travel time in a calendar layout, the calendar application of some embodiments presents the walking travel time item and the driving travel time item visually differently. FIGS. 6 and 7 illustrate that the calendar application of some embodiments differentiates the walking and driving travel time items by simply placing a car or walking-man indicator (e.g., an icon, a badge, etc.) within the travel time item. These figures illustrate the same two appointments on the same day as those shown in FIGS. 4 and 5, respectively, except that the FIGS. 6 and 7 show the two appointments in a five-working day, weekly calendar view.

As shown in FIG. 6, the travel time item 625 includes a travel mode badge 626 showing a car to indicate that the travel time is being specified based on the time to drive to the location of the appointment from a previous location. The mode of transportation associated with an appointment may be identified by a user or computed by the calendar application based on different known or predicted data in some embodiments. As shown in FIG. 7, the travel time item 725 includes a travel mode badge 726 showing a walking pedestrian, in order to indicate that the travel time is being specified based on the time to walk to the location of the appointment from a previous location. Other icons may also be used in different embodiments to indicate other modes of transportation, such as public transit (e.g., a bus, a train, etc.), bicycle, etc. Also, in some embodiments, the travel time for the different modes of transportation can be differentiated through other visual representations, such as different colors, boundary highlights, etc.

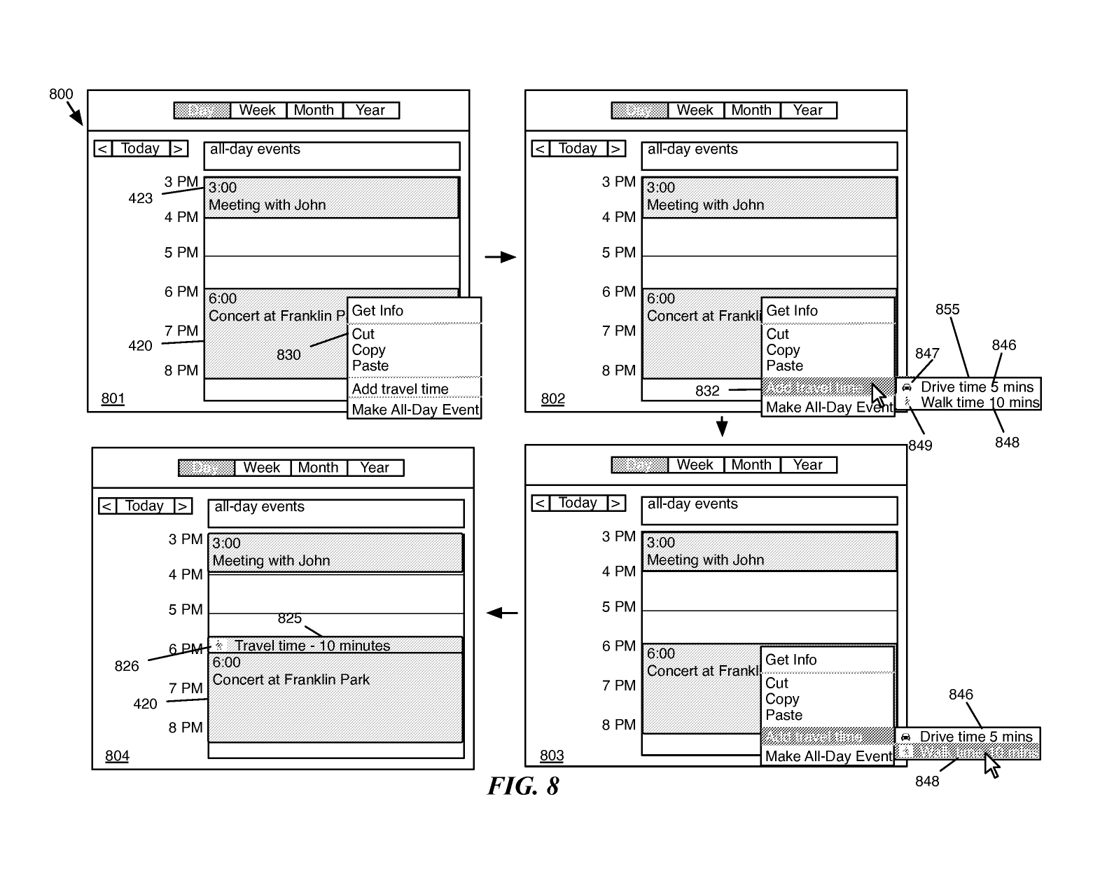

The calendar application of some embodiments allows a user to select a mode of transportation that is used to specify the travel time to or from the location of an appointment. FIG. 8 illustrates an example of a GUI 800 of one such calendar application. The GUI 800 in this example is identical to the GUI 400 of FIG. 4, except that the GUI 800's contextual menu 830 provides two options for the user to specify two modes of transportation, namely driving and walking. This example presented in FIG. 8 is illustrated in four stages 801-804.

The first stage 801 shows the GUI 800 after the contextual menu 830 has been invoked for the appointment 420. The second stage 802 shows that after the selection of the “Add travel time” option 832, the calendar application presents a sub-menu 855 that includes a drive time option 846 and a walk time option 848. The drive time option 846 includes a travel mode icon 847 that indicates that the mode of transportation is driving. The drive time option 846 also indicates, in text, that the mode of transportation is driving and an estimated driving time of 5 minutes. The walk time option 848 includes a travel mode icon 849 that indicates that the mode of transportation is walking. The walk time option 848 also indicates, in text, that the mode of transportation is walking and an estimated walking time of 10 minutes.

In the third stage 803, a user selects the walk time option 848. As shown in the fourth stage 804, upon the selection of the walk time option 848, the calendar application adds a travel time item 825 to the appointment item 420. The travel time item 825 shows the travel mode icon 826, which indicates that the user selected walking as the method of travel to the concert. In this example, the text for the travel time item may also include the expected travel time (i.e., 10 minutes) as shown.

### II. Specifying or Calculating Travel Times

As mentioned above, the calendar application of some embodiments allows a user to statically specify the travel time for an appointment, or to direct the application to dynamically compute the travel time for an appointment. Also, in some embodiments, the calendar application automatically computes the travel time for an appointment based on user-specified preferences.

Some embodiments allow the user to statically enter travel time for an appointment by selecting a travel time from a list of candidate travel times, or by entering a travel time in a custom travel time field. A user may statically enter the travel time for many different reasons. For example, a user may have specific knowledge regarding the travel time for the appointment, such as where the user plans to be when leaving for the appointment, additional preparation time needed to travel, etc.

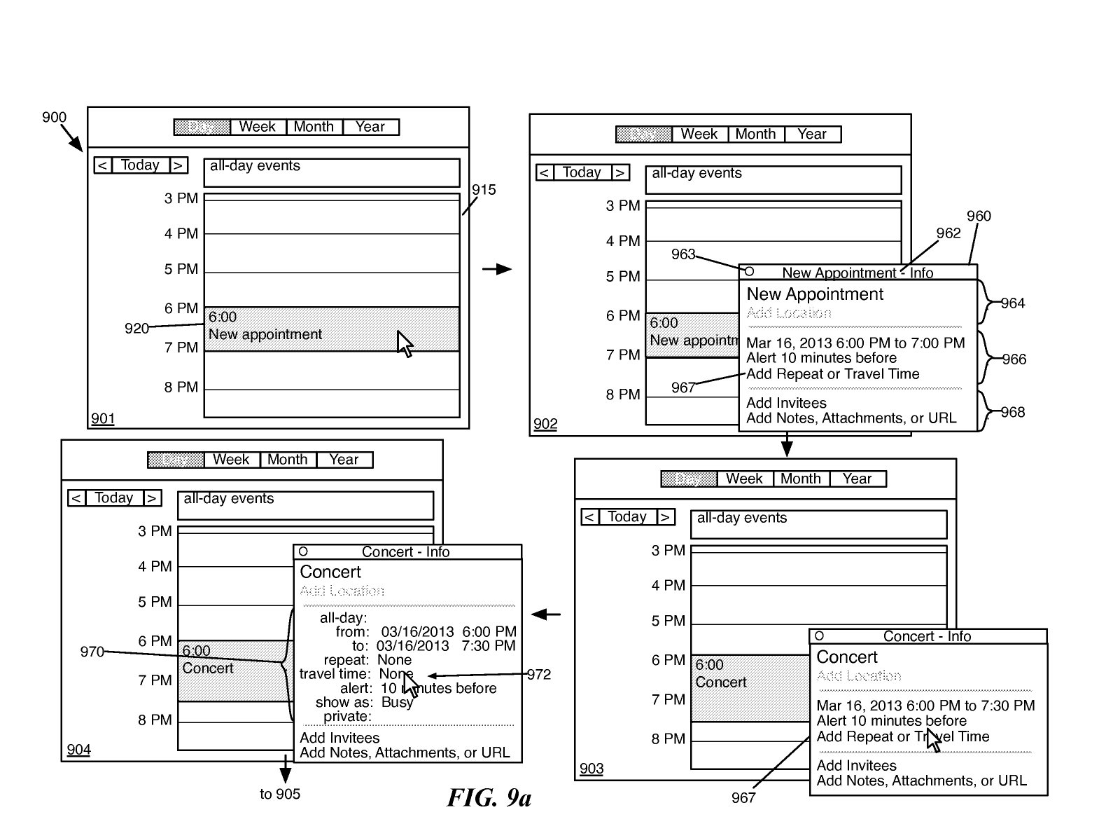

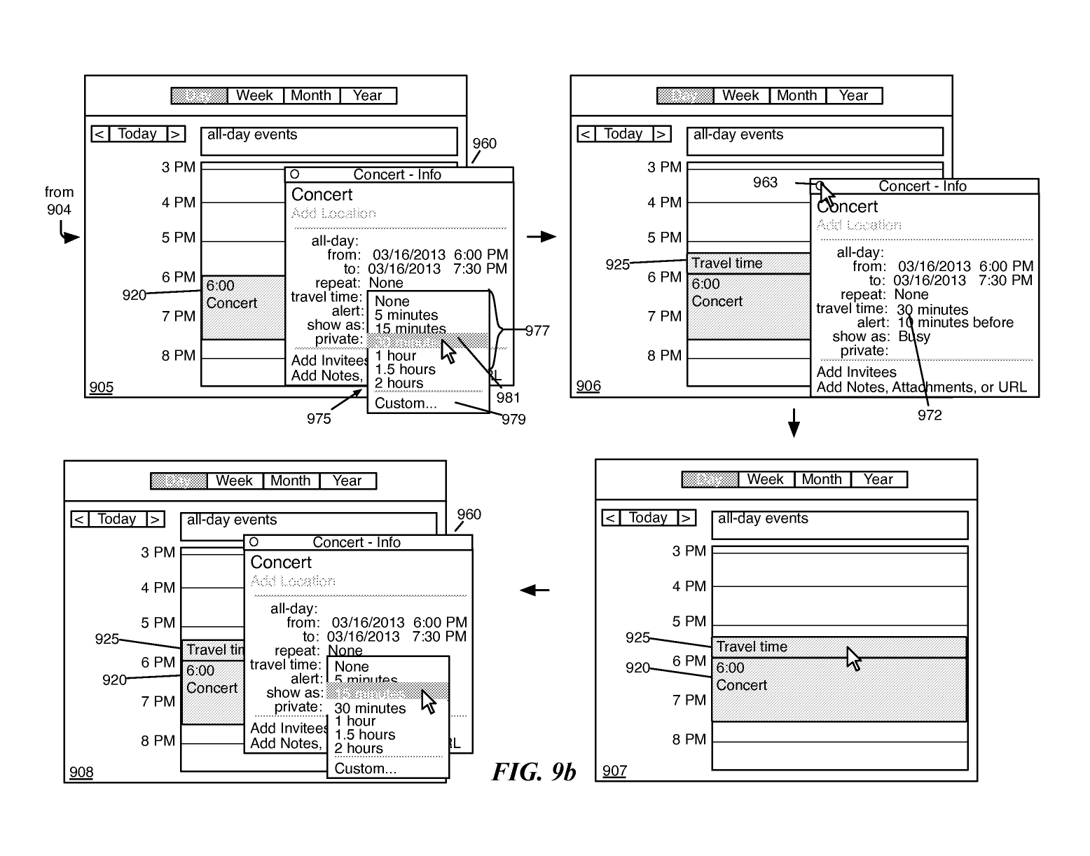

For some embodiments of the invention, FIGS. 9a and 9b illustrate one manner by which a user selects the travel time for an appointment from a list of pre-specified travel times. Specifically, these figures illustrate the user's interaction with a GUI 900 of a calendar application in eight stages 901-908. The first stage 901 shows a daily calendar layout 915 with an appointment item 920. This appointment item 920 is for a new appointment starting at 6:00 PM.

The second stage 902 shows the calendar layout 915 after an information pane (or an inspector) 960 has been invoked for the appointment item 920 (e.g., by performing a right-click operation). In some embodiments, this information pane 960 includes a title bar 962, an appointment detail section 964, an appointment time section 966, and a miscellaneous section 968.

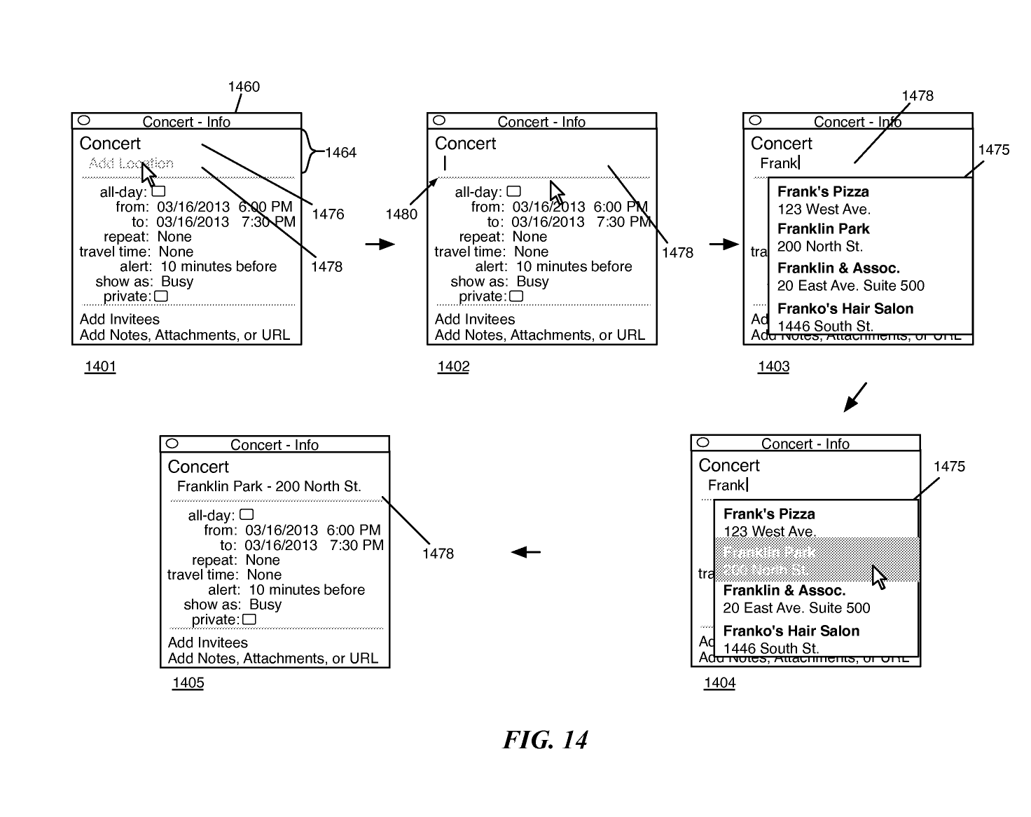

The title bar 962 is for showing the name for the appointment, which is currently set to New Appointment, and includes a close control 963 for closing the menu. The appointment detail section 964 also shows the name for the appointment and includes a field for adding a location to the appointment. In the appointment detail section 964, the name for the appointment can be added or modified by the user, and a location can be added for the appointment, as further described below by reference to FIG. 14.

The appointment time section 966 shows the date, and the start and end times for the appointment. The appointment time section 966 also shows information regarding alerts related to the appointment. This section further includes an option 967 for adding a repeat or a travel time, which allows the user to specify a recurrence schedule for the appointment or add a travel time for the appointment, as further described below. The miscellaneous section 968 includes other appointment options such as the options for sending invitations to invitees, adding notes, and adding attachments.

The third stage 903 shows the information pane 960 after the user has changed (not shown) the name for the appointment to Concert in the appointment detail section 964. The user has changed this name by selecting New Appointment in the second stage 902 and typing Concert. The third stage 903 also shows the user selecting the Add Repeat or Travel Time option 967 to display an expanded appointment section in order to provide details for the appointment item 920.

As shown in the fourth stage 904, when the Add Repeat or Travel Time option 967 is selected, the calendar application displays an expanded appointment time section 970 for providing or modifying additional details for the appointment item 920. The expanded appointment time section 970 shows modifiable fields to change the start and end times for the appointment, to change the date for the appointment, to make the appointment a recurring appointment, to add an alert, etc. In addition, the expanded appointment time section 970 now shows a travel time field 972 for specifying the travel time for an appointment. In the fourth stage 904, the travel time field 972 indicates that no travel time has currently been specified for the appointment 920. The fourth stage 904 illustrates the user selecting the travel time field 972.

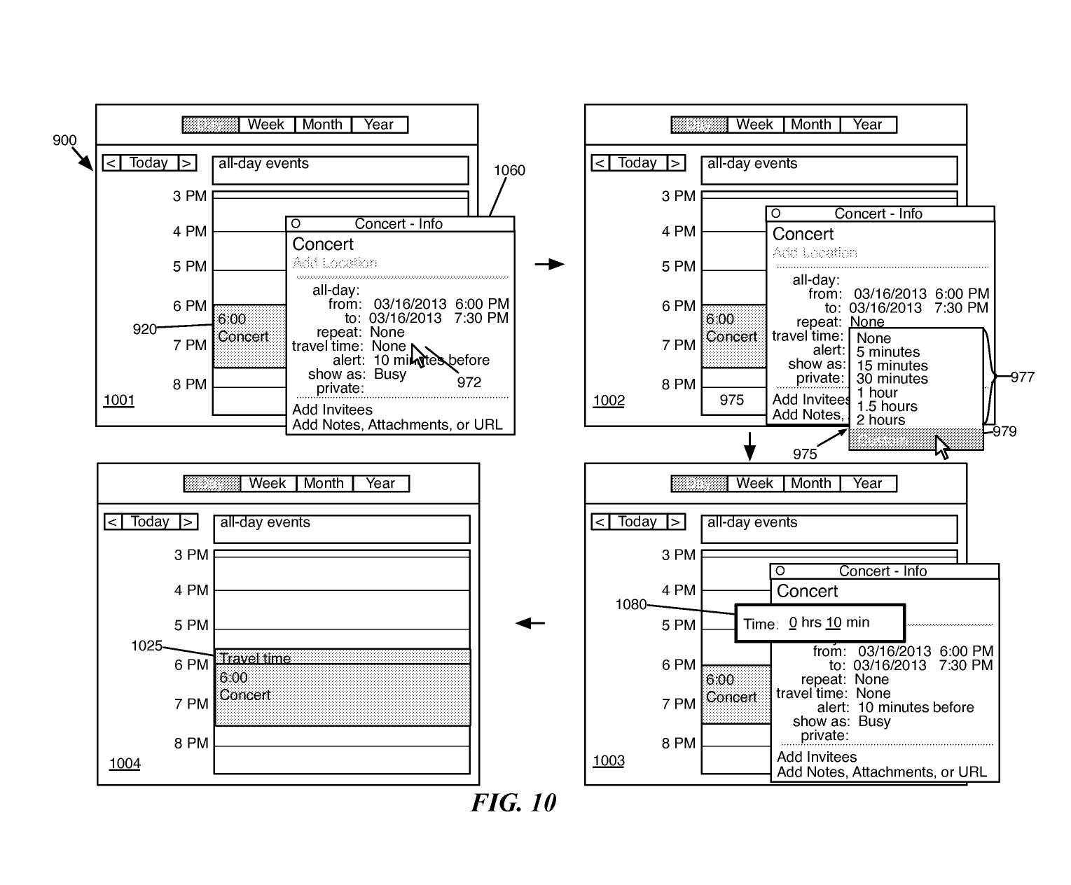

The fifth stage 905 illustrates that, in response to the selection of the travel time field 972 in the previous stage 904, the calendar application displays a drop-down menu 975. The drop-down menu 975 includes a list of static travel times 977 and a custom option 979. The static travel times are common travel times that may be set to estimate the travel time to an appointment. In this example, this list of static travel times includes the following options: None, 5 minutes, 15 minutes, 30 minutes, 1 hour, 1.5 hours, and 2 hours. Alternative to or in conjunction with the list, the custom option 979 of some embodiments allows the user to enter the travel time, as described further below by reference to FIG. 10. The fifth stage 905 also illustrates the user selecting the option 981 for “30 minutes” from the list of static travel times 977.

The sixth stage 906 illustrates that, upon selection of an option from the list of static travel times 977, the calendar GUI 900 creates a travel time item 925 with a travel time of 30 minutes for the appointment item 920. The travel time of 30 minutes is also indicated in the travel time field 972 in the information pane 960. The sixth stage 906 also shows the user selecting the close button 963 to close the pane 960. The seventh stage 907 shows the GUI 900 with the newly added travel time item 925 for the appointment item 920. In the seventh stage 907, the user selects travel time item 925.

In some embodiments, the travel time items are selectable user interface (UI) items. The eighth stage 908 shows that when the user selects a travel time item 925 in stage 907, the GUI 900 again displays the information pane 960 with a drop-down menu to adjust the travel time of the travel time item 925. In this example, selecting the travel time item 925 allows the user to modify details regarding the travel time. In other embodiments, the calendar application displays a similar information pane with different features from information pane 960. The calendar application of some embodiments displays different types of information for a travel time item. For instance, in some embodiments when a user selects the travel mode icon of a travel time item, the calendar application displays a map and/or directions for a route (e.g., the route used to calculate the travel time) associated with the travel time item.

FIG. 10 illustrates an example of setting a custom travel time for an appointment in four stages 1001-1004. The first stage 1001 shows the selection of the modifiable travel time field 972 in the information pane 960 for the appointment 920. This selection directs the calendar application to present the drop-down menu 975 as shown in the second stage 1002. The drop-down menu 975 shows the list of static travel times 977 and the custom option 979. However, instead of selecting one of the static travel times 977, the user selects the custom option 979 in the second stage 1002 of FIG. 10.

The third stage 1003 illustrates that the selection of the custom option 979 directs the calendar application to provide a window 1080 to the user in some embodiments, to allow the user to enter a custom period of time. In this example, the user enters 10 minutes in this window (e.g., by inputting the desired numbers on a keyboard). The user could not have selected this time amount from the list of static travel times 977 as 10 minutes is not one of the choices in this list. The fourth stage 1004 shows the calendar application after it has added the travel time item 1025 of 10 minutes for the appointment item 920.

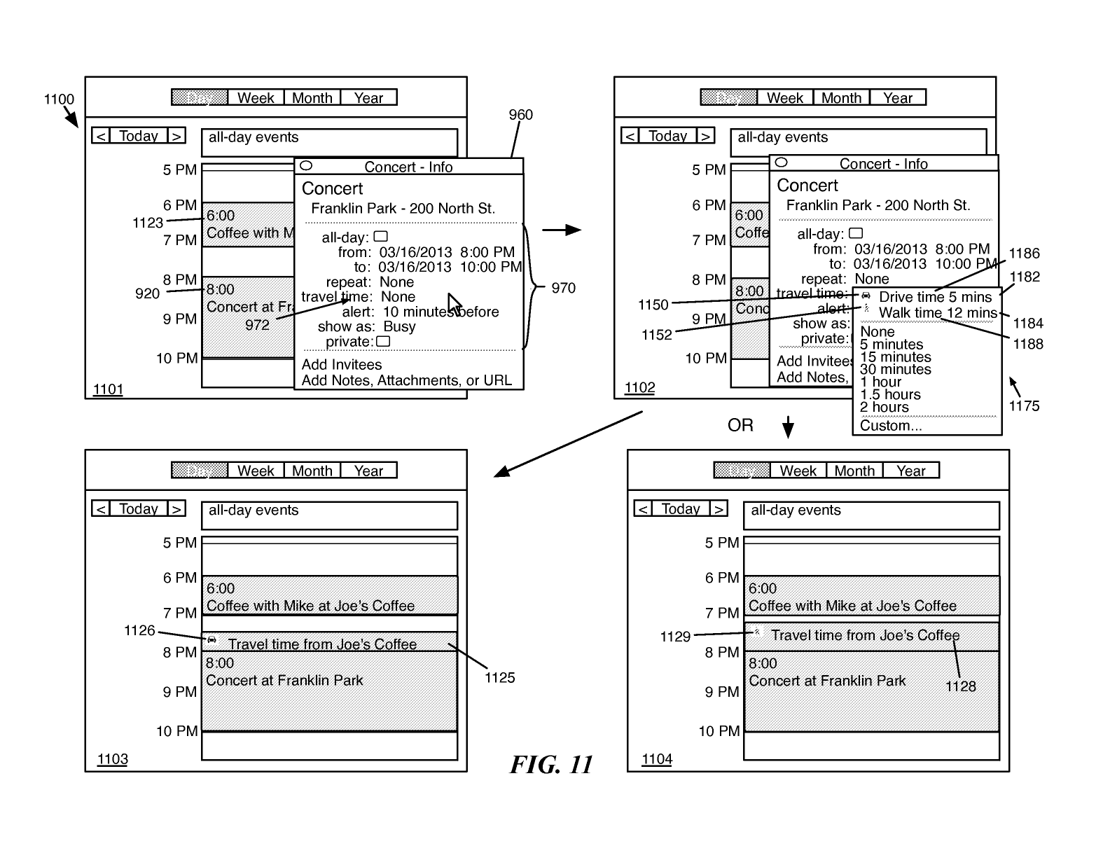

In addition to allowing the user to select or specify from a static list of travel times or entering a custom travel time for the appointment, the calendar application in some embodiments also provides options that, when selected, would direct the application to compute one or more travel times for one or more modes of transportation. FIG. 11 illustrates one such approach. In three stages 1101-1104 (where the third stage has two alternatives 1103 and 1104), this figure shows the presentation of driving and walking travel times along with the static list of travel times and the custom option for entering a custom travel time. The first alternative 1103 of the third stage shows the selection of a driving time option, while the second alternative 1104 shows the selection of a walking time option.

Like the GUI 900 shown in the fourth stage 904 of FIG. 9, the first stage 1101 shows a GUI 1100 with the information pane 960 for the appointment 920. The contextual menu shown here has an expanded appointment time section 970. The first stage also shows a prior appointment item 1123 for an appointment for coffee with Mike at Joe's Coffee. In this example, the prior appointment item 1123 has a defined location (i.e., Joe's Coffee). The first stage 1101 also shows the selection of the travel time field 972 in the expanded appointment time section 970.

The second stage 1102 shows that this selection has caused the GUI 1100 to show a drop-down 1175. However, unlike the drop-down menu 975 of FIG. 9, the drop-down menu 1175 shows two user-selectable options for calculated travel times in addition to the static list and custom time options. The two options are a calculated driving time option 1182 and a calculated walking time option 1184.

The calculated driving time option 1182 shows a mode icon 1150 with an image of a car and a description 1186. Similarly, the calculated walking time option 1184 shows a second mode icon 1152 with an image of a pedestrian and a description 1188. The mode icons 1150 and 1152 allow a user to quickly determine the mode of transportation used to calculate the travel time. The descriptions 1186 and 1188 provide the estimated travel times from a start location to the location of the appointment using the particular mode of transportation.

Depending on which option is selected from drop-down 1175, a different travel time item is displayed in the calendar layout. The first alternative third stage 1103 shows the resulting travel time item 1125 when the driving time 1182 option is selected in the second stage 1102. The travel time item 1125 of stage 1103 shows an image of a car as the mode icon 1126 to indicate that the travel time to the concert is based on driving directions to the concert from Joe's Coffee.

Alternatively, the second alternative third stage 1104 shows the resulting travel time item 1128 when the walk time option is selected in the second stage 1102. The travel time item 1128 of the fourth stage 1104 shows a pedestrian as the mode icon 1129 to indicate that the travel time to the concert is calculated based on walking directions to the concert from Joe's Coffee.

In the examples illustrated in FIG. 11, the calculated travel times 1182 and 1184 have been computed based on the locations of the previous appointment and the current appointment. Once these locations are known, the calendar application computes the travel time before or after the user picks a particular mode of transportation. Such a computation will be further described below. Also, the discussion below will further describe how the calendar application of some embodiments computes the travel time when the location before or after the appointment's location is not known.

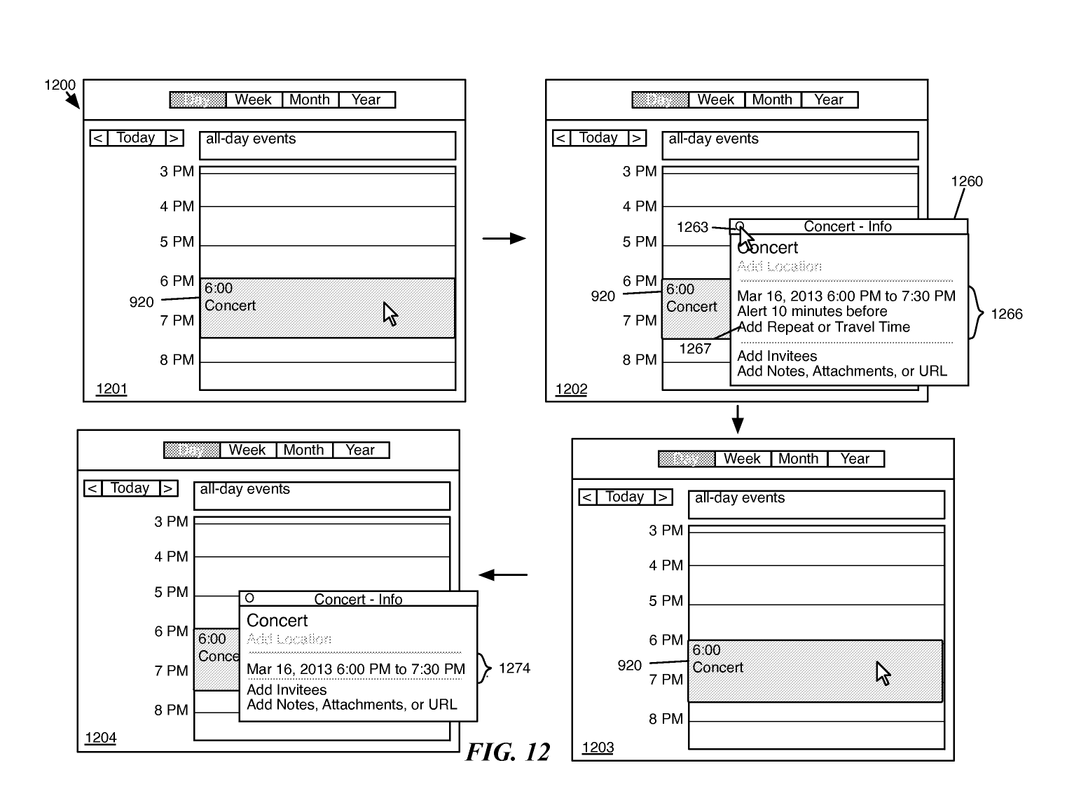

In some embodiments, the option for adding a travel time item is only a subtle, transient reminder to the user that is removed from the contextual menu after the first time or the first few times that it is presented to the user for an appointment. It is provided as a reminder in order to encourage a user to take advantage of the travel time features. However, it is removed from the contextual menu for an appointment in order to reduce the clutter in this menu. FIG. 12 illustrates an example of removing this reminder after it has been presented in the contextual menu initially. This example is illustrated in four stages 1201-1204.

The first stage 1201 shows a GUI 1200 of a calendar application that displays a daily calendar layout with appointment item 920. In the first stage, the user selects appointment item 920.

The second stage 1202 shows that, upon selection of the appointment item 920, the calendar application brings up the information pane 1260. Like the pane 960 of FIG. 9, the pane 1260 includes an appointment time section 1266 along with other sections. The appointment time section 1266 shows the date, start and end times for the appointment, and alert information, as well as the Add Repeat or Travel Time option 1267. The Add Repeat or Travel Time option 1267 serves as a reminder to the user to add further details to the appointment, such as a recurrence schedule or travel time for the appointment. In the second stage 1202, the user selects the close button 1263 to close the information pane 1260.

The third stage 1203 shows that after closing the information pane 1260, the user again selects the appointment item 920. The fourth stage 1204 then illustrates the re-opened information pane 1260. However, this time, the pane 1260 shows an abbreviated time section 1274 that only displays the date, and start and end times for the appointment. The abbreviated section 1274 no longer shows the Add Repeat or Travel Time option 1267 for adding a travel time to the appointment. While initially providing a reminder to users to add a travel time for an appointment, subsequent views of the information pane 1260 provide the abbreviated time section to allow the user to quickly see details of the appointment. In some embodiments, selecting the abbreviated time section 1274 will still display an expanded time section like the one described in stage 904 of FIG. 9 to allow the user to update the travel time for an appointment. However, by not showing the more detailed time section 1266 shown in stage 1202, the calendar application is able to provide a more succinct view of the appointment.

In some embodiments, rather than adding travel times based on user input, the calendar application automatically adds travel times for events based on user-specified preferences. The user may specify settings to automatically add a travel time before and/or after an appointment. The calendar application of some embodiments calculates the automatically added travel time. In order to calculate the travel times, the calendar application of some embodiments uses other user-specified preferences such as a default location and a default mode of transportation. The default location is used as a starting location for calculating a travel time to a destination location specified by a new appointment. The default mode of transportation is used to calculate the time it takes to travel a route from the default location to the specified destination location. More details about calculating the travel times will be discussed below in Section III.

### III. Calculating Travel Times

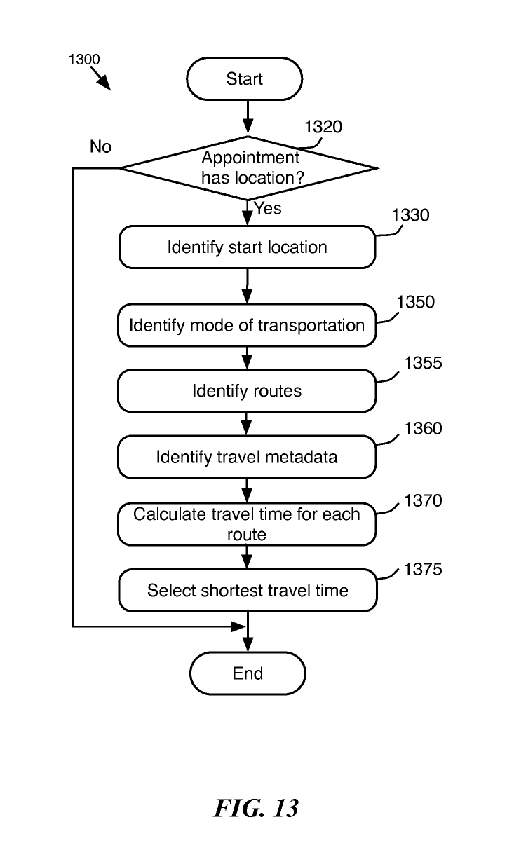

In some embodiments, the calendar application calculates travel times for an appointment based on a set of different variables. FIG. 13 conceptually illustrates a process 1300 that the calendar application of some embodiments performs to calculate the travel time for an appointment. The process 1300 is performed in some embodiments after the user requests that a travel time item be added for an appointment, while in other embodiments it is performed automatically by the calendar application when an appointment is created without the user specifically requesting that the travel time be computed.

In some embodiments, the calendar application automatically adds the travel time item for an appointment to the calendar layout after it computes the travel time, while in other embodiments, it simply presents the results of the computation in a menu through which the user can request the addition of the travel time for the appointment. The options 1182 and 1184 in the contextual menu 1175 of FIG. 11 are examples of how the calendar application of some embodiments presents the results of its travel time computations so that the user can view these computations before selecting either of the travel time options. In the example illustrated in FIG. 11, the computed driving and walking travel times are respectively shown as 5 and 12 minutes.

The process 1300 begins by determining (at 1320) whether a location is available for a particular appointment. The location for the appointment is usually received from the user through, for example, a user interface such as the one described below by reference to FIG. 14. When the process determines (at 1320) that an appointment location is not available, the process ends. In some embodiments, when an appointment has no location, the calendar application can still allow the user to enter the travel time for an appointment through the pre-specified list of travel times or through the prompt for a custom travel time.

When the process determines (at 1320) that a location for the appointment has been identified, the process identifies (at 1330) a start location from which the user is traveling to the location of the appointment. The process 1300 of different embodiments identifies a start location in many different ways. For instance, the start location may be received directly from the user while the user is requesting the addition of the travel time item (e.g., the user may provide this location in the contextual menu through which the user asks for the addition of travel time item). Alternatively, like the example provided in FIG. 11, the start location may be identified based on the location of a previous appointment. In some such embodiments, the calendar application only uses the location of a previous appointment when this appointment is within a certain amount of time (e.g., 30 minutes, 2 hours, etc.) from the appointment for which it is computing the travel time. When the user has not specified any start location, the process 1300 of some embodiments uses additional heuristics to identify a start location. These heuristics are described in further detail below by reference to FIGS. 15-16.

Once the process 1300 has identified (at 1330) a location for the appointment and a start location, the process identifies (at 1350) the mode of transportation which the process is to use to compute the travel time. The process 1300 identifies the mode of transportation differently in different embodiments. For instance, in some embodiments, the mode of transportation for a particular appointment is provided by the user. The user may enter a mode of travel for each appointment, or may set a preference for a particular mode of transportation in the user's settings. Alternatively or conjunctively, the process 1300 may automatically identify a mode of transportation based on other available information (e.g., route distances, weather information, etc.). In some embodiments, the process 1300 uses several different modes of transportation to compute the travel time. In this manner, the process can provide different estimates of travel time for different modes of transportation, as described above by reference to FIG. 8.

Once the process 1300 has identified (at 1350) a mode of transportation, the process identifies (at 1355) several routes between the appointment location and the start location for the identified mode of transportation. The identified routes in some embodiments are the shortest routes or the routes that historically have been the fastest between the appointment location and the start location for the identified mode of transportation. In some embodiments, the process identifies the routes by using a routing engine that executes on the same device that executes the process 1300. In other embodiments, the process identifies the routes by using an external routing service communicatively coupled to the device that executes the process. In some such embodiments, the process provides the appointment location, the start location, and method of travel to the internal or external routing engine, which then computes one or more routes between the location for the appointment and the start location.

Once the routes have been identified (at 1355), the process 1300 identifies (at 1360) travel metadata for each of the identified routes. In some embodiments, the travel metadata is data that may affect the travel time along a route at the time for the particular appointment. Examples of such metadata for a route include traffic data, weather forecasts, holiday schedules, etc. Using the route, mode of transportation, and travel metadata, the process 1300 calculates (at 1370) the travel time for each of the identified routes. After computing the travel time, the process then selects (at 1375) the shortest travel time as the travel time between the appointment location and the start location for the mode of transportation identified at 1350. The process then ends.

A. Appointment Location

With the appointment location, start location, and mode of transportation, the calendar application of some embodiments identifies the route and computes travel time for a particular appointment. The manner for specifying or identifying each of these variables will now be described by reference to FIG. 14-20.

FIG. 14 illustrates an example of setting a location for an appointment in five stages 1401-1405. The first stage 1401 shows an information pane 1460 that is similar to the information pane 960 described above by reference to FIG. 9. As shown, the information pane 1460 displays details regarding a Concert appointment in this example. The appointment detail section 1464 of the information pane 1460 includes a title field 1476 and a location field 1478. The title field displays the title of the appointment, Concert. In the first stage 1401, the user selects the location field 1478.

In the second stage 1402, in response to the selection of the location field 1478, the GUI of the calendar application of some embodiments displays a text cursor 1480 indicating that the location field 1478 is being edited. In the third stage 1403, the user has begun typing in a name for the location of the appointment. Based on this input, the calendar application of some embodiments searches a database for known locations and provides matching known locations in a drop-down window 1475. Searching for known locations ensures that a particular location can be found in a map. The database may be accessed through a map framework (e.g., Apple™ Maps, etc.) that provides maps and directions for various locations. Alternatively or conjunctively, the database may include recent searches or searches that were initially entered at another remote computer. A list of these known locations and their addresses is then presented in the drop-down menu 1475.

In the fourth stage 1404, the user selects a known location, Franklin Park, from the drop-down menu 1475. The fifth stage 1405 shows that the calendar application sets the location for the appointment to Franklin Park at 200 North St. While the example illustrated in FIG. 14 shows the user selecting the location of the appointment from one of the known locations, one of ordinary skill will realize that the information pane 1460 may allow the user to specify this location differently. For instance, in some embodiments, the user provides this location by typing in the address of the appointment in the field 1478.

B. Start Location

FIG. 15 conceptually illustrates a process 1500 that the process 1300 uses (at 1330) in some embodiments to identify the start location for computing travel time for a particular appointment. The process 1500 is used by the process 1300 when the process 1300 is to compute the travel time to a location for an appointment. However, in other embodiments, a similar process can be used to identify the destination location for a travel time for traveling from an event to a destination.

The process 1500 initially determines (at 1520) whether there are other prior appointments, from which the user is likely to travel to the particular appointment. In the example described in FIG. 11, the location for the coffee was identified as the location for the appointment scheduled prior to the concert appointment. In some embodiments, the process 1500 only determines that a user will travel from a prior appointment when the prior appointment is within a specific time window of the particular appointment (e.g., 3 hours). Hence, in these embodiments, the process 1500 will not treat appointments that do not fall in the time window as prior appointments. When the process determines (at 1520) that there is such prior appointment with a specified location, the process 1500 identifies (at 1525) the prior location as the location specified for the prior appointment, and the process ends.

On the other hand, when the process determines (at 1520) that there is no location for an appropriate prior appointment, the process determines (at 1530) whether location data for the user is available through real time data collection. For instance, during a certain time interval (e.g., two hours) before the particular appointment, the process examines whether it can gather the location information (e.g., global positioning system (GPS) coordinates) of the user from the user's smartphone or other device that has location tracking services. In some embodiments, the user's location data is only tracked if the user agrees that his location should be tracked in order to provide certain services (such as travel time computation) to the user. Also, in some of these embodiments, the user's location is only maintained on devices owned by the user.

When the process determines (at 1530) that the location of the user is available, the process sets (at 1535) the prior location to the user's location, and then ends. Otherwise, the process 1500 determines (at 1540) whether the time interval before the particular appointment falls within the parameters of any of its rules for heuristically predicting the user's location. When the process 1500 can predict the location of the user prior to the particular appointment, the process sets (at 1545) the prior location to the predicted location and then ends.

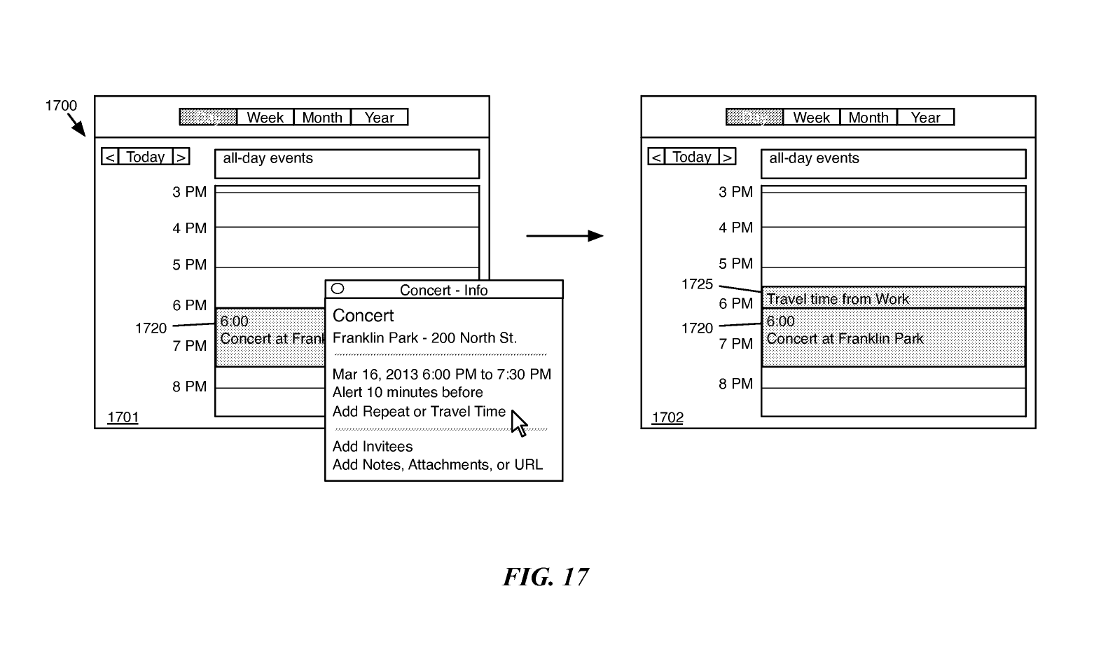

Examples of the heuristics (i.e., these decision-making rules) the process 1500 uses in some embodiments are illustrated FIGS. 16 and 17. The heuristics used in these examples specify the user's home as the prior location when the application determines that the appointment is outside of the user's work hours (e.g., between the hours of 8 am to 6 pm). The heuristics specify the user's work as the prior location when the application determines that the appointment is within the user's work hours. Some embodiments identify the user's home and work addresses from the user's contact settings (e.g., vCard) that are stored on the device executing the above- and below-described processes of the invention.

FIG. 16 illustrates an appointment item 1620 for a breakfast at 7:30 AM. No other appointment is scheduled for the day before this breakfast. Given that 7:30 AM is outside of the work hours, the process 1500 specifies the location of the user's home as the prior location for this appointment. Accordingly, the process 1300 computes a travel time from the user's home, as indicated by the travel time item 1625 in the second stage 1602 of FIG. 16.

FIG. 17 illustrates an appointment item 1720 for a concert at 6:00 PM. No other appointment is scheduled for the day before this concert. Given that 6:00 PM is right after the work hours, the process 1500 specifies the prior location as the location of the user's work. Accordingly, the process 1500 computes a travel time from the user's work, as indicated by the travel time item 1725 in the second stage 1702 of FIG. 17.

Coming back to FIG. 15, when the process 1500 cannot predict the location of the user prior to the particular appointment by using its heuristics, the process uses (at 1550) a default location for the prior location and then ends. In some embodiments, the default value will be a user's home address, and when the process 1500 cannot determine a prior location for a travel time, the travel time will be calculated from this home address. As mentioned above, the default starting location may be set by the user through, e.g., a preferences window as described above.

In some embodiments, the process 1300 performs process 1500 or portions of process 1500 repeatedly before the time for the particular appointment, in order to identify a prior location or to improve the accuracy of the prior location. For instance, for the embodiments that track the user's location through the location of the user's smartphone, the process 1300 repeatedly performs the operation 1530 before the time for the particular appointment, even after it has specified the prior location to be the location of a prior appointment or to be a location predicted through its heuristics. This is because real-time gathered data about the user's location will provide more accurate estimates of the user's location before the particular appointment.

As mentioned above, the user's data on a device may provide a user's work address and working hours. When such data is not available, some embodiments identify the user's work and home addresses in terms of a general or specific location from data regarding the user historic locations. Analysis of the historic location data may identify patterns that show a particular user is likely to be at a general address (e.g., a city or neighborhood region) or specific address between 10 AM to 5:30 PM, and at another general address or specific address during 12 AM to 7 AM. Based on some heuristics, some embodiments then specify the general or specific address between 10 am to 5:30 PM as the user's work address, and the general or specific address between 12 am to 7 am as the user's home address.

As mentioned above, the identification of a prior location is not necessarily a one-time evaluation. In some embodiments, even when a travel time for an appointment has a prior location, the start location may be re-evaluated when details for the appointment change. For example, if the starting time for the concert in FIG. 17 were moved to 9:00 PM, the calendar application would determine that the user is no longer likely to go directly to the concert after work. The application would then update the travel time of travel time item 1725 to calculate the time between the user's home and the concert. In some embodiments, the calendar application would provide an alert to notify the user when the prior location for a travel time changes.

C. Mode of Transportation

In some embodiments, as described above in the example of FIG. 11, the calendar application presents a set of travel times to the user so that the user can select a desired mode of transportation. This may be done for each individual travel time as it is created. In some embodiments, the user sets a default mode of transportation in the user's preferences. The calendar application uses the default mode of transportation to compute travel times. Alternatively or conjunctively, a travel time based on one of the different modes of transportation is automatically selected for the appointment.

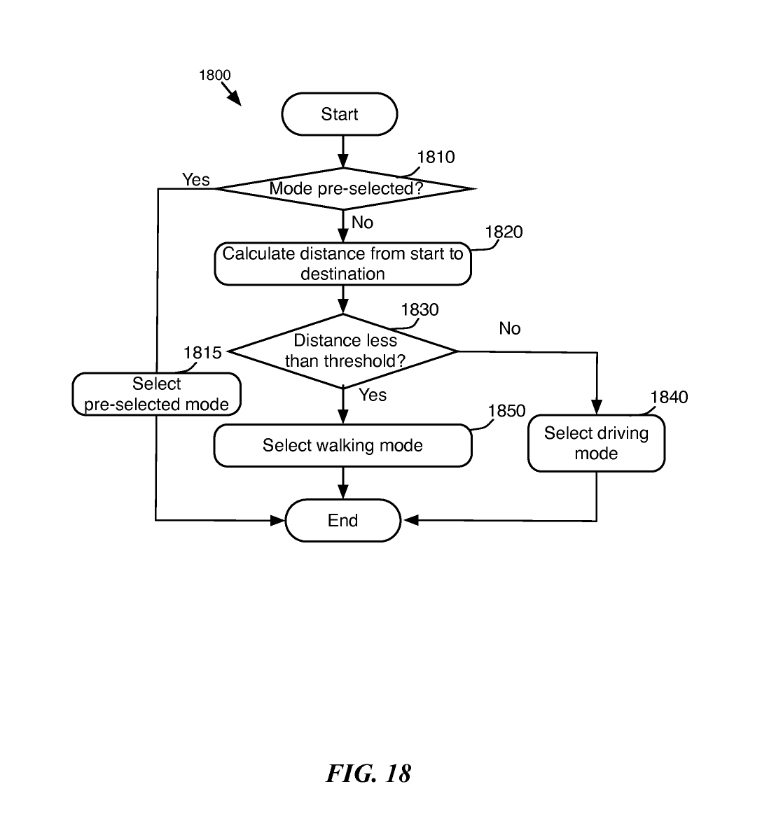

FIG. 18 conceptually illustrates a process 1800 that the calendar application in some embodiments performs to automatically select a mode of transportation for computing travel time for an appointment. The process 1800 begins by determining (at 1810) whether a travel mode has been pre-selected. In some embodiments, a mode of transportation for computing travel time for the appointment is deemed pre-selected when a user has set a mode of transportation for the appointment or specified a preferred or default mode of transportation in the user's preferences. When the process 1800 determines (at 1810) that a travel mode has been pre-selected, the process 1800 selects the pre-selected mode and the process ends.

When the process 1800 determines (at 1810) that a travel mode has not been pre-selected, the process calculates (at 1820) the distance between the start location and the destination location of the travel. As mentioned above, the start location is a location before an appointment and the destination location is the location of the appointment in some cases, while the start location is the appointment's location and the destination location is a location after the appointment in other cases. The process then determines (at 1830) whether the distance is less than a specified threshold value. In some embodiments, the threshold value is set by a user in the user's preferences, while in other embodiments it is a value specified by the calendar application. For example, the user or the application may specify that routes with distances less than 3 miles should default to walking

If the process determines (at 1830) that the distance is greater than the threshold value, then the process specifies (at 1840) the travel mode as the driving mode and then the process ends. If the process determines (at 1830) that the distance is within the threshold value, the process specifies the travel mode as the walking mode and the process ends. In some embodiments, the process may evaluate other variables to determine whether to select between various other methods (e.g., public transit, bicycling, etc.). These variables in some embodiments include the availability of bike paths, transit schedules, weather, etc. In some embodiments, these variables also include data about the travel modes that the user has historically used.

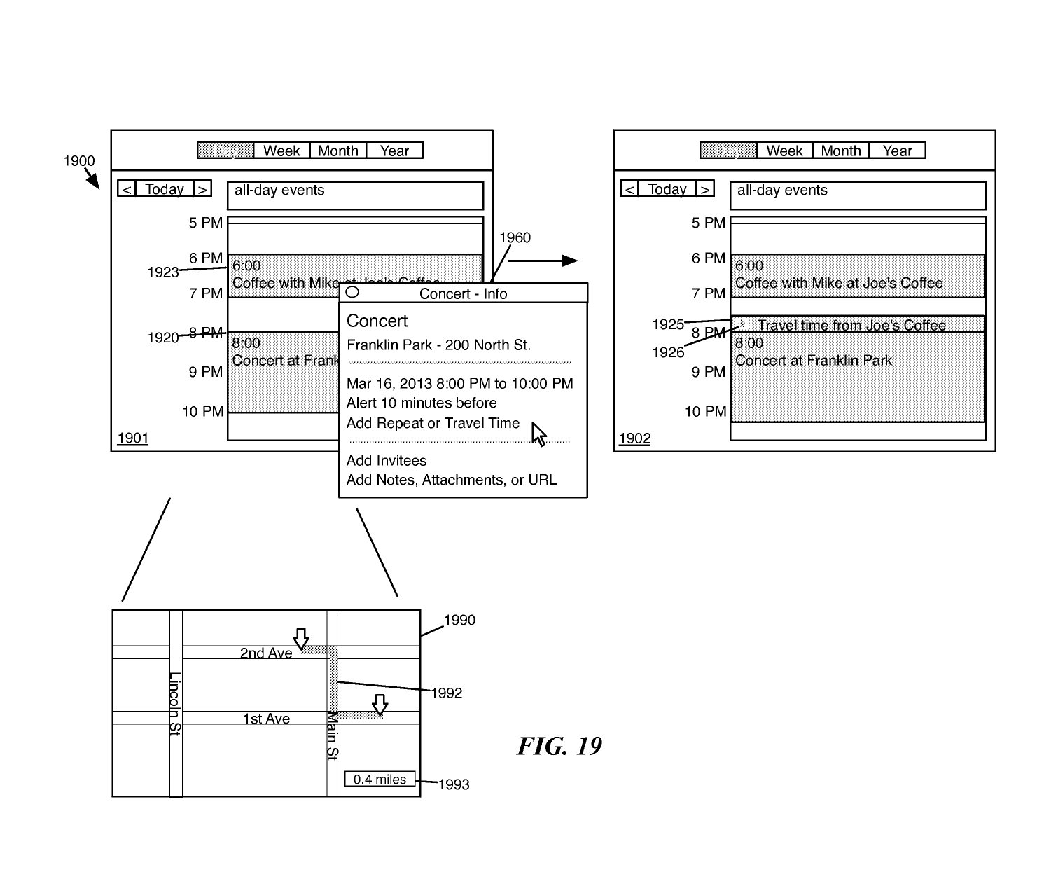

FIG. 19 illustrates, in two stages 1901 and 1902, an example of determining a mode of transportation for computing a travel time to a location for an appointment. The first stage 1901 shows a GUI 1900 of the calendar application of some embodiments, and an information pane 1960 that has been opened for an appointment 1920 for a concert. A map 1990 depicted below the first stage 1901 shows a route 1992 between Joe's Coffee for an appointment 1923 and Franklin Park for the appointment 1920. The map 1990 includes a distance output 1993 that shows that the distance between the two locations to be 0.4 miles. The map 1990 is not displayed while the GUI 1900 of the calendar application is displayed in some embodiments. The map 1990 is depicted in this figure for illustrative purpose.

The second stage 1902 shows the GUI 1900 after the walking travel time item 1925 has been added to account for the travel from Joe's Coffee to Franklin Park. The added travel time item 1925 shows the travel mode icon 1926 with an image of a pedestrian. Since the distance output 1993 was only 0.4 miles, the calendar application selected walking as the mode of transportation for calculating the travel time between the locations of the two appointments. Although in these embodiments the different variables are automatically determined, some embodiments provide multiple options for the user to specify the mode of transportation for the travel time computation.

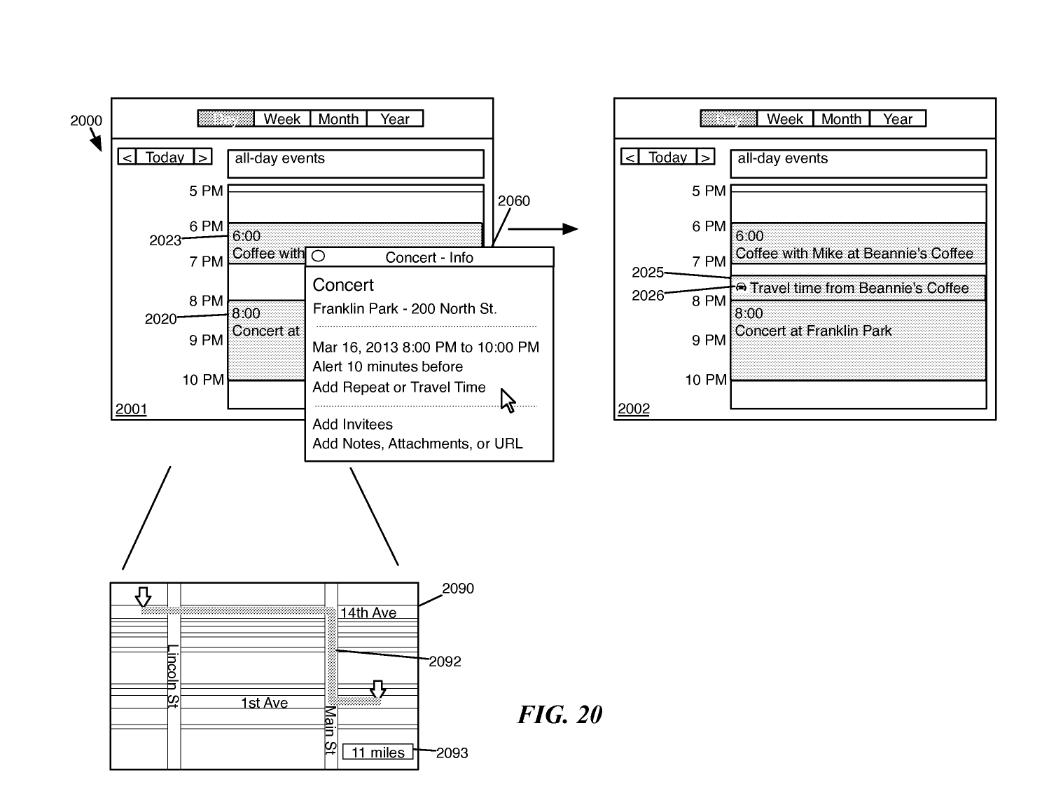

FIG. 20 illustrates, in two stages 2001 and 2002, another example of determining a mode of transportation for computing a travel time to the location of an appointment. Like the first stage 1901 of FIG. 19, the first stage 2001 shows a GUI 2000 of the calendar application of some embodiments, and a contextual menu 2060 that has been opened for an appointment 2020 for a concert. A map 2090 depicted below the first stage 2001 indicates that a route 2092 between Beannie's Coffee for an appointment 2023 and Franklin Park for the appointment 2020. The map 2090 includes a distance output 2093 that shows that the distance between the two locations to be 11 miles.

The second stage 2002 shows the GUI 2000 after the driving travel time item 2025 has been added to account for the travel from Beannie's Coffee to Franklin Park. The added travel time item 2025 shows the travel mode icon 2026 with an image of a car. Since the distance measurement 2080 was 11 miles, and this distance was greater than the threshold distance for selecting walking as the travel mode for the user, the calendar application selected driving as the mode of transportation for calculating the travel time between the locations for the two appointments.

### IV. Map Display in Calendar

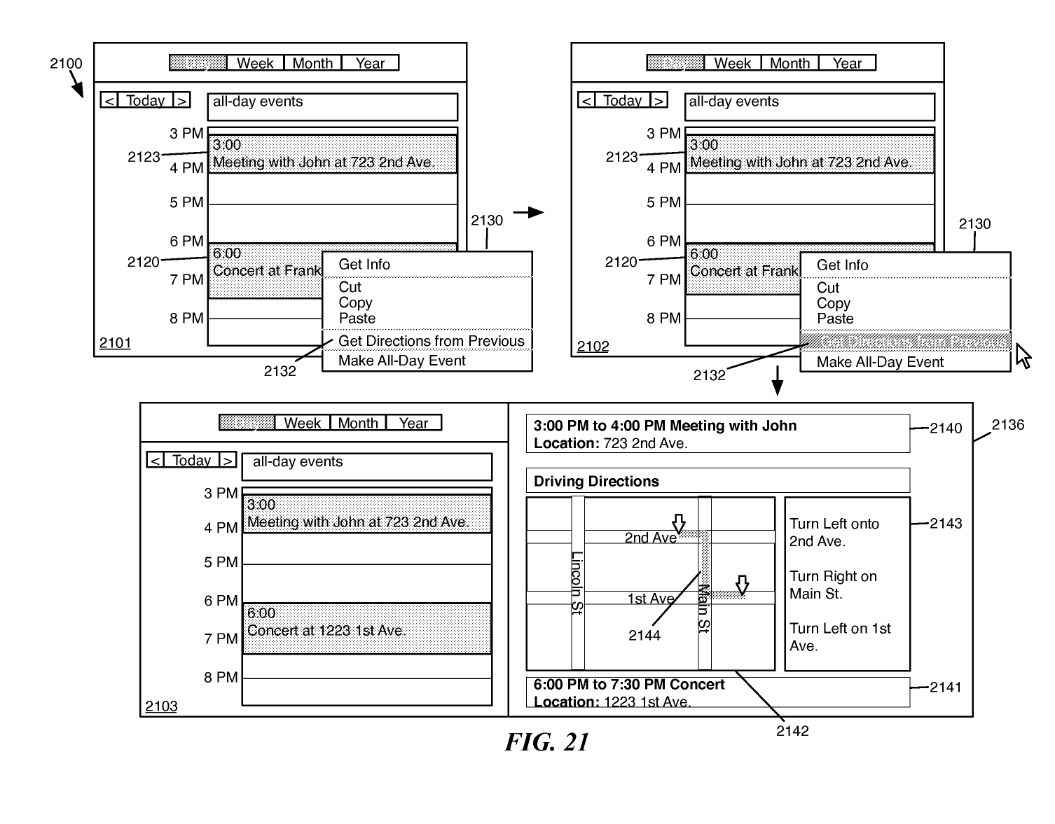

In addition to specifying travel times for appointments based on locations of appointments, the calendar application of some embodiments allows the user to view the appointment locations on a map. FIG. 21 illustrates one such calendar application 2100. In three stages 2101-2103, this figure shows an example of displaying a map and providing directions to the location of an appointment. The first stage 2101 shows the GUI 2100 after a contextual menu 2130 has been invoked for an appointment 2120. Unlike the menus described above, the contextual menu 2130 includes an option 2132 for getting a route and navigation instructions to the destination from a location of a prior appointment. In some embodiments, the calendar application may provide additional directions options, such as getting directions to a different location after the appointment.

The second stage 2102 shows the selection of the option 2132. In response to the selection of the option 2132, the GUI 2100 provides a route window 2136, as illustrated in the third stage 2103. The route window 2136 displays a start location 2140, a destination location 2141, a map 2142, and driving directions 2143. The map 2142 shows a route 2144 from the address of the start location 2140 to the address of the destination location 2141. The driving directions 2143 show textual driving instructions for the route 2144. As described above, the calendar application calculates the route 2144 based on an appointment location, a previous appointment's location (which in this example is the meeting with John at 723 2^{nd} avenue), and a mode of transportation.

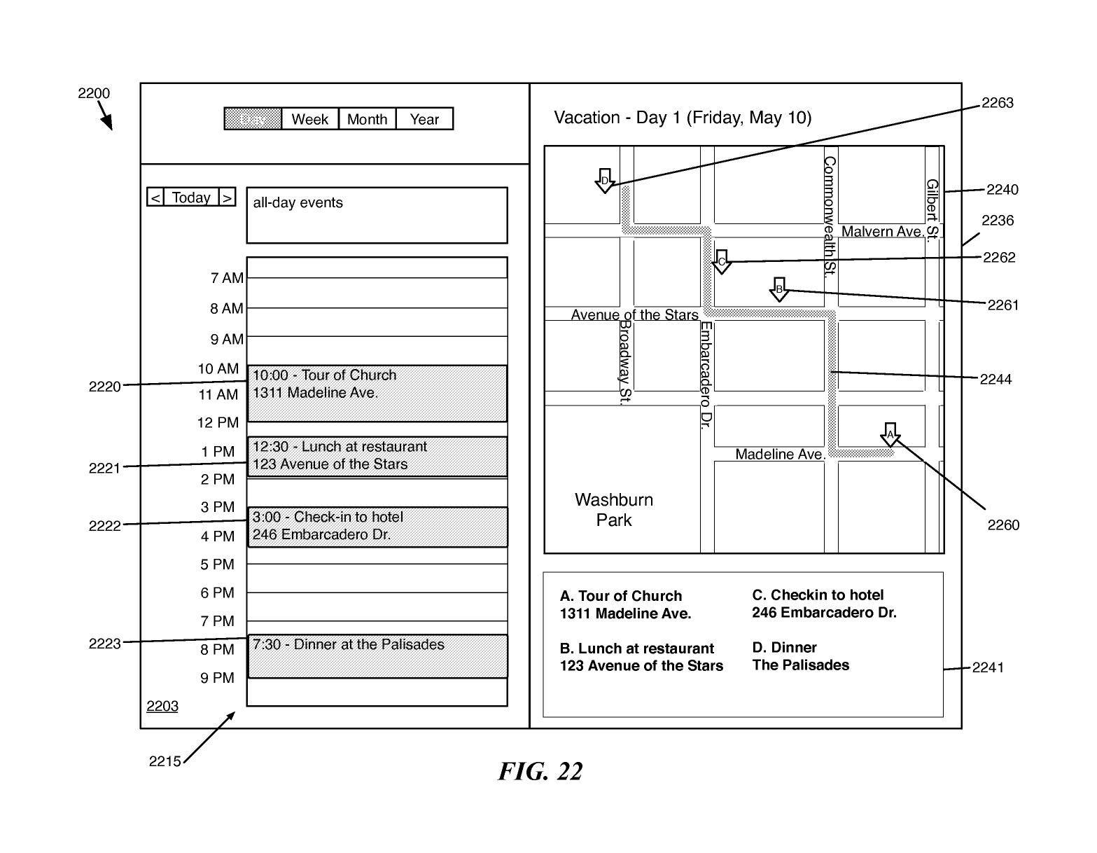

FIG. 22 illustrates displaying a map with a route for a day's itinerary. Specifically, this figure shows an example of displaying a map and a route for an itinerary. The itinerary in this example is a collection of events at different locations. As shown, a GUI 2200 displays several appointment items 2220-2223 on calendar layout 2215. The GUI 2200 also shows a route window 2236 for showing a map and directions for the appointment items 2220. The route window 2236 displays itinerary location markers 2260-2263, a map 2240, and an itinerary description 2241.

The map 2240 shows a route 2244 between the locations of the various appointments 2220-2223 of the itinerary. The map also displays a location marker at the location of each appointment in the itinerary. Itinerary description 2241 shows a summary of the scheduled appointments in the itinerary, along with the location for each. The calendar application of some embodiments calculates the route 2244 based on a location from each appointment to the next using a process similar to process 1300 described by reference to FIG. 13. In some embodiments, selecting a particular appointment item from the calendar layout 2215 will cause the map 2240 to show the routes to and from the location of the appointment. In some embodiments, travel time items may also be shown for each appointment item.

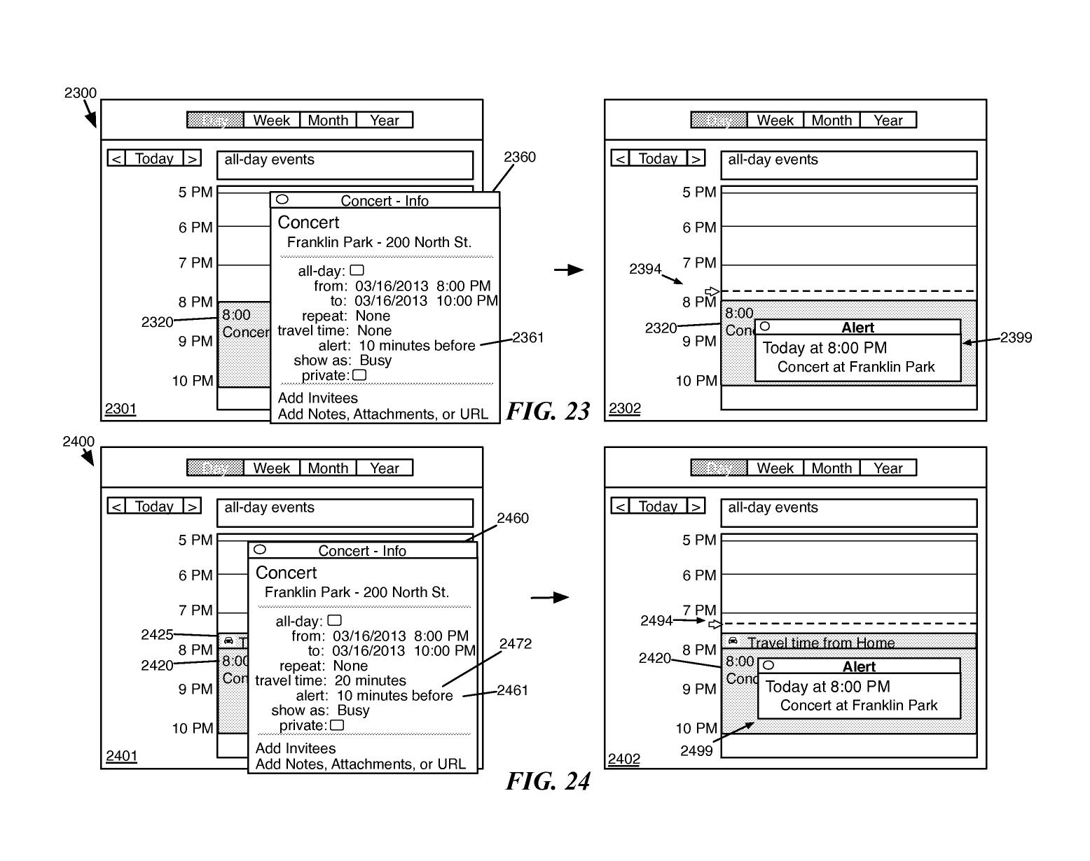

In addition to displaying maps and directions for a route to an appointment, the calendar application in some embodiments uses the calculated travel times for more than just displaying in the calendar layout. FIGS. 23 and 24 illustrate using the calculated travel times for notifications associated with an appointment. FIG. 23 illustrates an example of providing a standard notification to a user about a scheduled appointment in two stages 2301 and 2302. The first stage 2301 shows GUI 2300 with appointment item 2320, and a contextual menu 2360 for the appointment item 2320. The contextual menu 2360 shows an alert field 2361 which indicates that an alert is set for 10 minutes before the appointment.

The second stage 2302 then shows a current time indicator 2394 and an alert window 2399. The current time indicator 2394 in some embodiments is a horizontal line that moves along the vertical axis of the calendar layout as the current time changes. In this example, the current time indicator 2394 indicates that the current time is shortly before the appointment item 2320. Since an alert was set for 10 minutes prior to the appointment in the first stage 2301, the second stage 2302 also shows alert window 2399 with details regarding the appointment.

In some embodiments, the calendar application offsets an alert for an appointment by the travel time associated with that appointment. For instance, if an alert is set for 10 minutes before an appointment, but there is a 20-minute travel time, the alert will be displayed 30 minutes (10 minutes for the alert +20 minutes travel time) before the appointment. FIG. 24 illustrates an example of this novel notification reminder regarding a scheduled appointment in two stages 2401 and 2402.

The first stage 2401 shows the GUI 2400 with an appointment item 2420, and a contextual menu 2460 that has been invoked for this appointment. The contextual menu 2460 shows an alert field 2461 that indicates that an alert is set for 10 minutes before the appointment. In contrast to the GUI 2300, the GUI 2400 shows a travel time item 2425 and a travel time field 2472. The travel time item 2425 and the travel time field 2472 indicate that the travel time to the location for appointment item 2420 is 20 minutes.

The second stage 2402 shows a current time indicator 2494 and an alert window 2499. In this example, the current time indicator 2494 indicates that the current time is 10 minutes before the travel time item 2425. Rather than providing an alert 10 minutes before the event, the calendar application in some embodiments offsets the alert time to provide a notification prior to the travel time to the appointment. In this case, the alert is triggered 10 minutes (i.e., the alert time) before the 20 minute travel time of appointment item 2420 (30 minutes before the appointment item 2420).

### V. Dynamic Changes to Travel Times

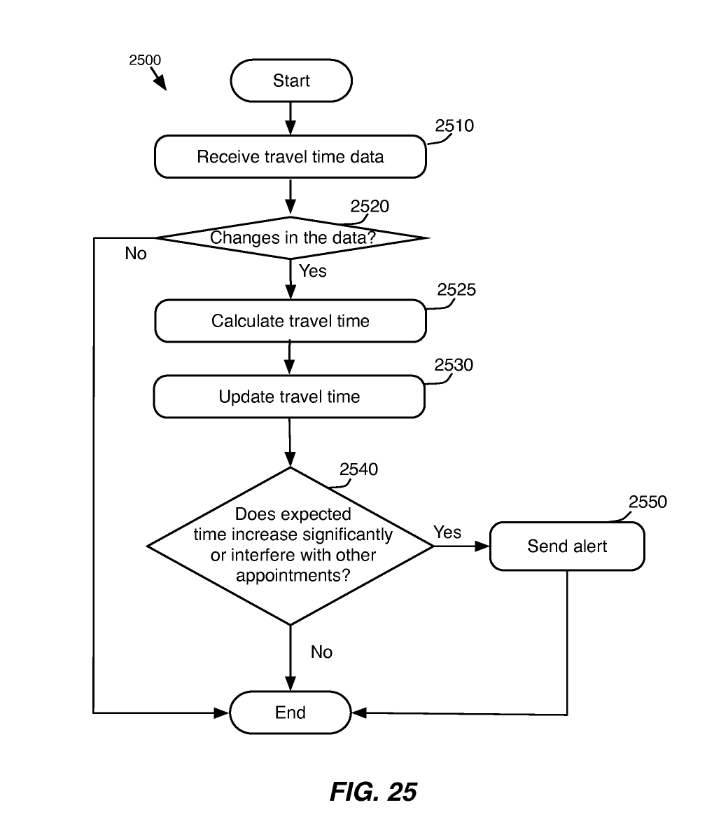

As seen in the examples provided above, the calendar application adds calculated travel times to appointments in the GUI of the calendar application. In some embodiments, once a travel time has been added for an appointment, the calendar application may receive updates in data associated with the travel time and may modify the travel time according to the updates as conditions change. FIG. 25 conceptually illustrates a process for updating travel time based on changes in travel metadata. In some embodiments, the travel metadata may be any data that affects the expected travel time for an appointment (e.g., GPS location, traffic, appointment locations (start or destination), time of day, weather, etc.). The process 2500 begins when travel metadata is received (at 2510). The process 2500 determines (at 2520) whether the received travel metadata is different from the current data (e.g., the metadata changes when a user moves to a new location). When the process 2500 determines that the data has not changed, the process 2500 ends.

When the process 2500 determines (at 2520) that the received travel metadata is different, the process calculates (at 2525) a new expected travel time for the route. The process updates (at 2530) the travel time for the appointment based on the new information. The process then determines (at 2540) whether the travel time increases significantly over a previously calculated travel time. In some embodiments, an increased travel time is significant when the new travel time interferes with neighboring appointments. Alternatively or conjunctively, an increased travel time may be significant if the change is greater than a threshold value. For example, the process 2500 may determine that any change more than 10 minutes is significant. Alternatively or conjunctively, the process 2500 may determine whether the changes are significant based on the percentage of the changes. For instance, changes that are 20% more than the duration of the previously calculated travel time are significant. For example, if the previous travel time was 30 minutes, a change greater than 6 minutes (20%) may be significant, while a change less than 6 minutes is not.

When the process 2500 determines (at 2540) that the change is not significant, the process ends. Otherwise, the process 2500 sends (at 2550) an alert to the user. For instance, the process may send an alert to the user by displaying a pop-up notification, sending an email, providing an audible cue, etc. In some embodiments, an alert is sent for any automatic change to the travel time for an appointment. The process then ends.

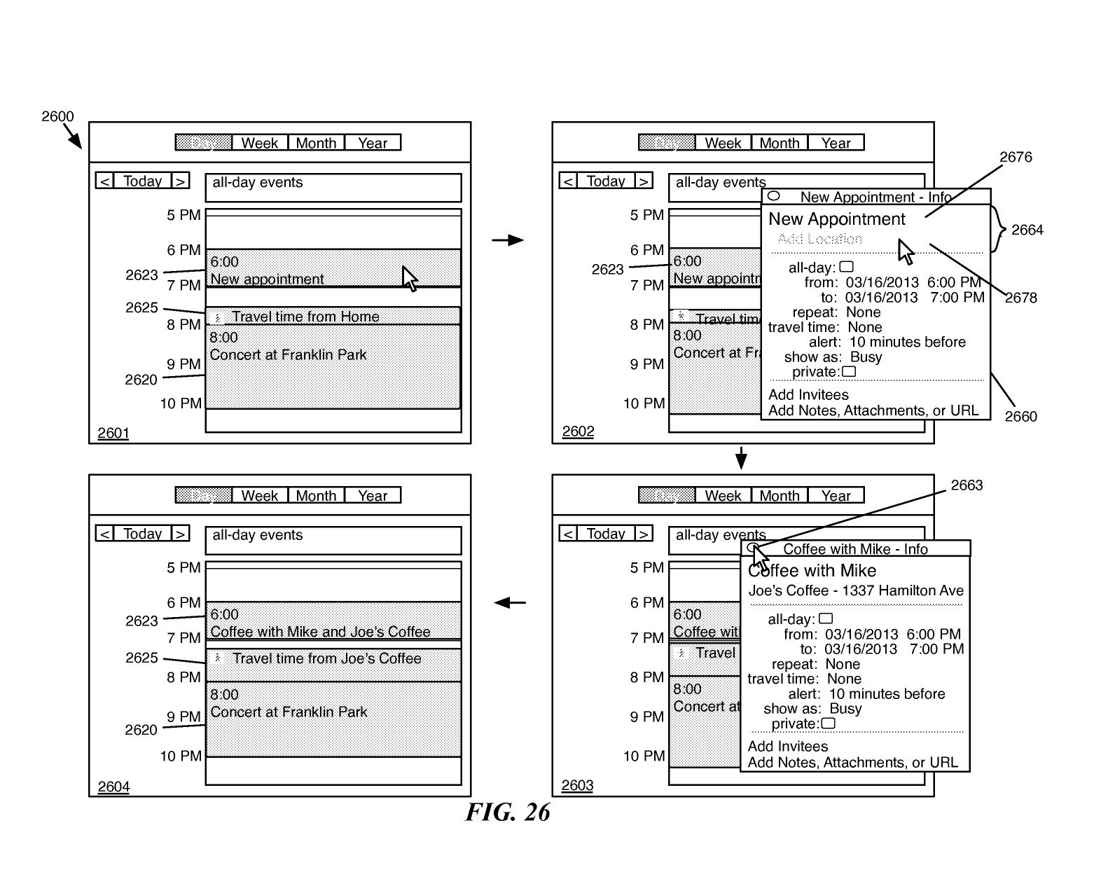

FIGS. 26-28 illustrate examples of dynamically changing the travel time for an appointment. FIG. 26 illustrates an example of dynamically changing the travel time for an appointment based on changes to other appointments in four stages 2601-2604. A GUI 2600 shows appointment items 2620 and 2623, as well as travel time item 2625. The appointment item 2620 is for a concert at Franklin Park. The appointment item 2623 is a new appointment at 6:00 PM with no location details. The travel time item 2625 indicates that the travel time is calculated based on a walking route from the user's home to the location of the appointment item 2620. The first stage 2601 shows that the user selects the new appointment item 2623.

In the second stage 2602, the information pane 2660 is shown for the new appointment. The information pane 2660 is like information pane 1960 from FIG. 19, with an appointment detail section 2664. The appointment detail section 2664 includes a title field 2676 and location field 2678.

In the second stage 2602, the user selects the location field 2678 of the appointment detail section 2664. As described above, the user enters details, including a location, for the new appointment item 2623.

In the third stage 2603, the GUI 2600 has updated the details for the new appointment item 2623 in the information pane 2660. As shown, the title field 2676 for the appointment item has now been changed to Coffee with Mike, and the location field 2678 has been set to Joe's Coffee at 1337 Hamilton Ave. In the third stage 2603, the user selects the close button 2663 to close the information pane 2660.

The fourth stage 2604 shows the results of the updated details for the new appointment item 2623. The travel time item 2625 for the appointment item 2620 has been updated to reflect the new information. Rather than traveling from the user's home, the travel time item 2625 shows that the travel time has been calculated from the location of the new appointment item 2623, Joe's Coffee. In this example, Joe's Coffee is further from Franklin Park than the user's home, so the travel time has increased from 15 minutes to 45 minutes.

In this example, when travel times are automatically re-calculated, the travel times are calculated with the same mode of transportation used to calculate the travel time originally. In some embodiments, when a travel time is re-calculated, the application will use the process 1800 of FIG. 18 to determine whether it has to use a new mode of transportation based on the updated information.

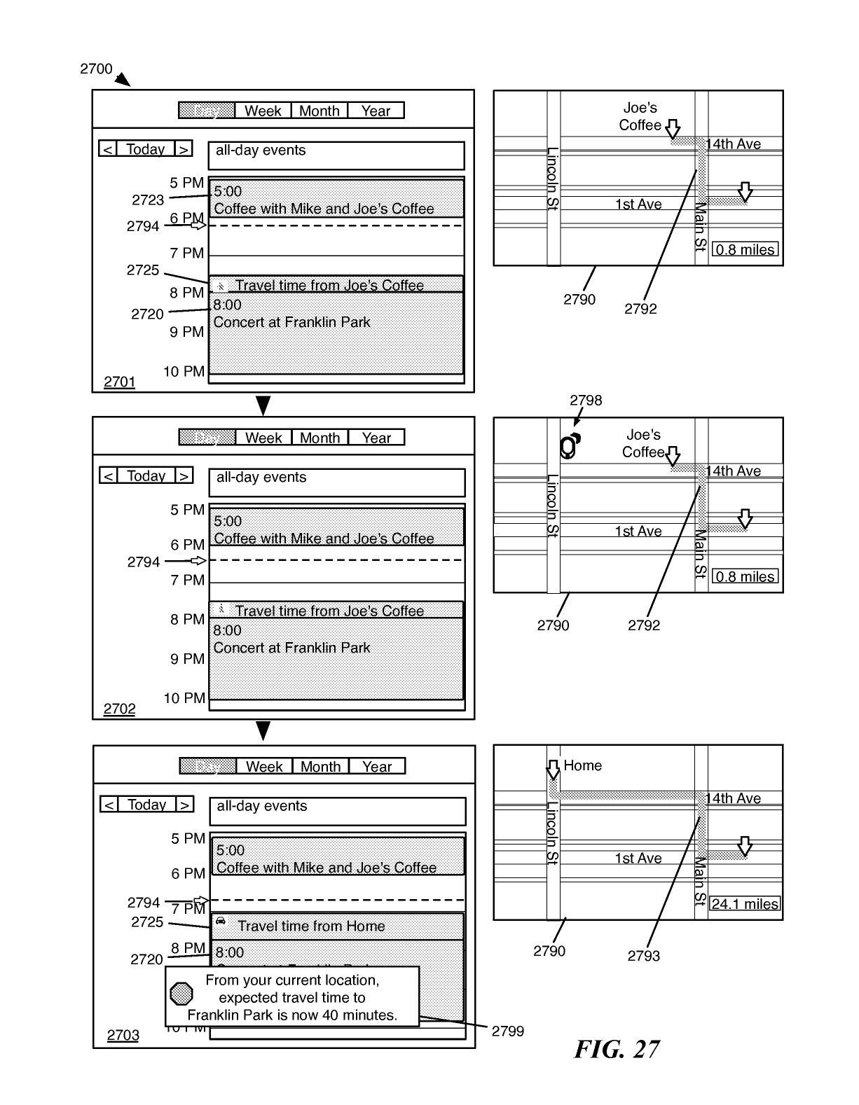

In some embodiments, the calendar application automatically updates the travel times for an appointment without any interaction with the user. FIG. 27 illustrates an example of dynamically changing the travel time for an appointment based on a detected change in the current location of the user in three stages 2701-2703 in the left half of the figure. The right half of the figure shows a map 2790 for each of the three stages.

The first stage 2701 shows the GUI 2700, similar to the GUI 2600 of FIG. 26. The GUI 2700 shows appointment items 2720 and 2723, and travel time item 2725. In addition, the first stage 2701 shows a map 2790 and time indicator 2794. The map 2790 shows a region with a route 2792 for the travel time item 2725, from Joe's Coffee to Franklin Park. A current time indicator 2794 indicates that the current time is 6:05 PM and that the appointment 2723 has just ended.

In the second stage 2702, the current time indicator 2794 indicates that the current time is now 6:15 PM. The map 2790 still displays the route 2792 from Joe's Coffee to the concert at Franklin Park for the second stage 2702. However, the map 2790 also shows that the user (i.e., the user's mobile device 2798) is now at a new location. The mobile device 2798 could be a mobile phone, tablet, laptop, or other mobile device. In some embodiments, the application may determine that a user is at a new location based on other information. For example, if a user logs in to a computer or is active on an account from an IP address associated with their home address, the application may determine that the user is now at home. Irrespective of whether the mobile device 2798 is used, the calendar application in the second stage 2702 determines that the user is now at a new location that is farther from the destination location than Joe's Coffee.

In the third stage 2703, the application updates the start location for travel time item 2725 because the user is at a new location. In this example, the calendar application determines that the new location is near the user's home, and generates a new route 2793 and a new travel time based on travel from the user's home to the concert. The map 2790 shows the new route 2793 from the user's home to the concert. The new route 2793 is longer than the original route 2792 and the travel time item 2725 has been adjusted accordingly. In addition to the length of the travel time for travel time item 2725, the mode of transportation has changed from walking to driving due to the increased distance. Automatically selecting a mode of transportation based on the distance to the destination location is discussed above by reference to FIGS. 18-20.

In addition, the third stage 2703 also shows an alert window 2799. In some embodiments, the alert window 2799 is shown whenever a travel time for an appointment is automatically modified. Alternatively or conjunctively, alert window 2799 is only provided to the user when the travel time for an appointment becomes longer or when the change in the travel time exceeds a threshold amount.

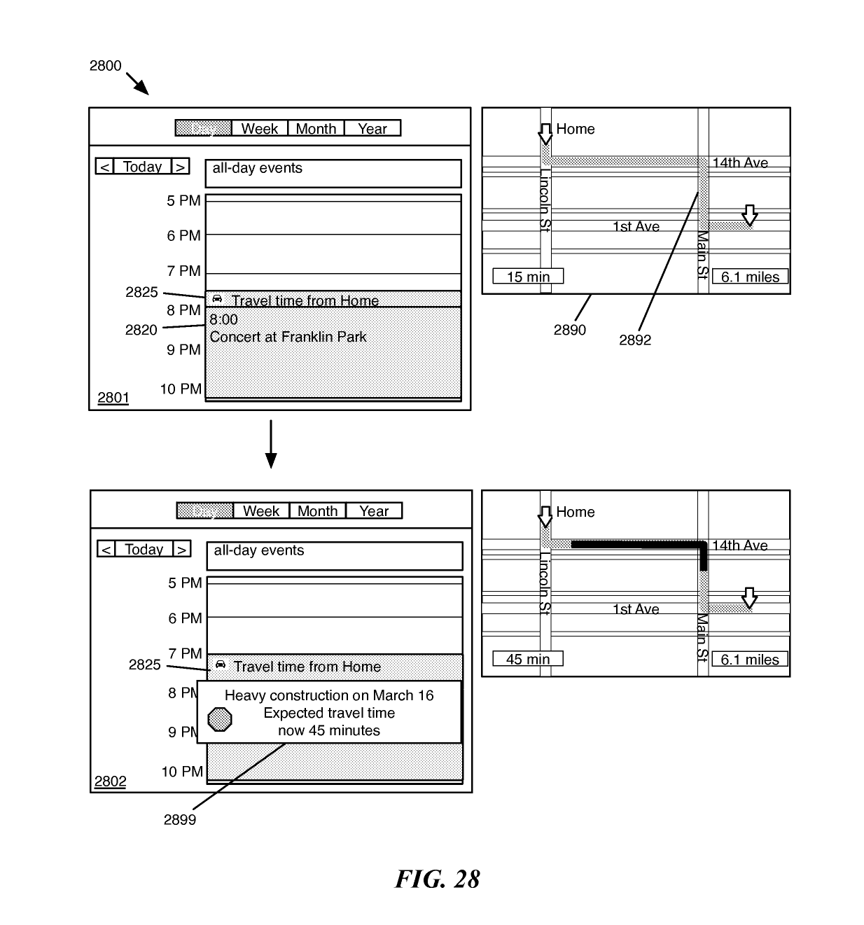

FIG. 28 illustrates an example of dynamically updating the travel time for an appointment based on traffic data in two stages 2801-2802. Like the first stage 2701 of FIG. 27, the first stage 2801 shows a GUI 2800 and a map 2890. The GUI 2800 shows an appointment item 2820 for a concert at Franklin Park and a travel time item 2825 from the user's home, but does not show any other appointment items. The map 2890 shows the route from the user's home to the concert at Franklin Park with the expected travel time based on traffic patterns at 7:45 PM.

In the second stage 2802, new traffic data has been received and the map 2890 shows that heavy traffic (shown in black) is now expected along a section 2895 of the route 2892. In this example, the calendar application takes note of this traffic, but does not change the route 2892. Instead, it shows the route 2892 with the increased traffic, and increases the expected travel time item 2825 from 15 minutes to 45 minutes according to the traffic data. In some embodiments, new routes are presented to the user to avoid traffic along a previously specified route. Like the alert window 2799 of FIG. 27, the alert window 2899 is shown when a travel time for an appointment is automatically modified. In some embodiments, the alert window 2899 informs the user of the reasons for the change.

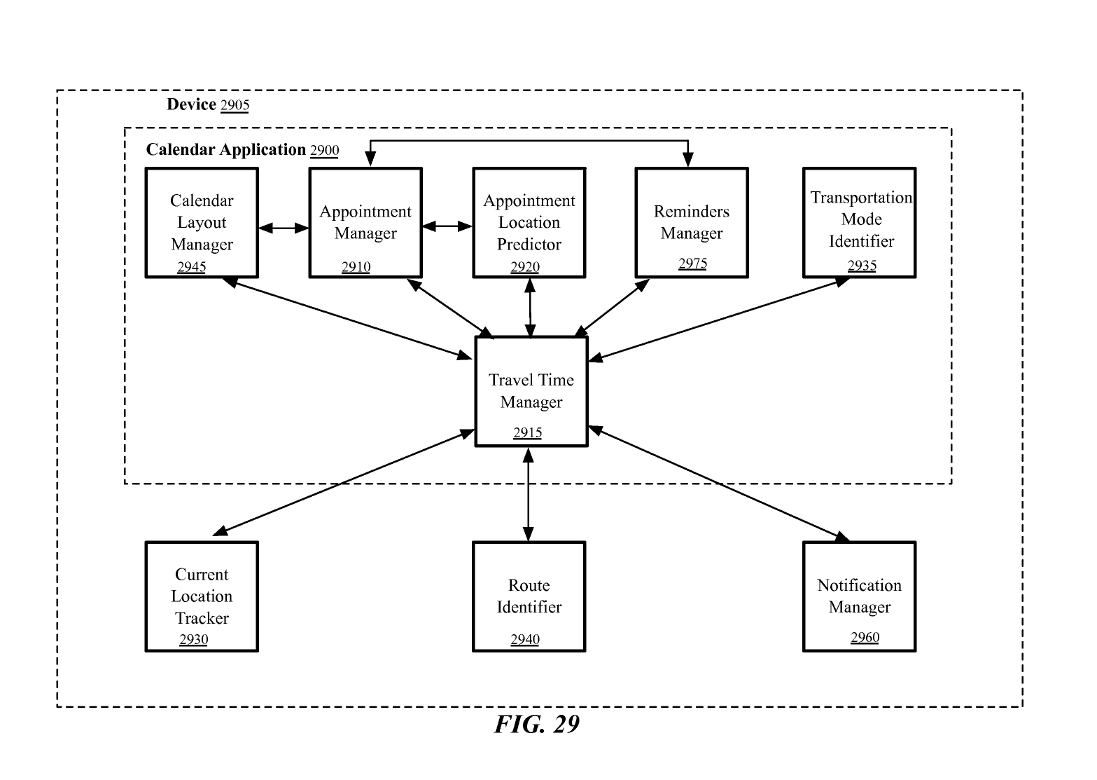

FIG. 29 conceptually illustrates example architecture of a calendar application 2900 that manages travel time items for appointments in the calendar. The calendar application 2900 executes on a device 2905. The calendar application 2900 includes an appointment manager 2910, a travel time manager 2915, an appointment location predictor 2920, a calendar layout manager 2945, a reminders manager 2975, and a transportation mode identifier 2935. Not all of the components of the calendar application 2900 are depicted in this figure for simplicity of illustration and description. This figure also illustrates a current location tracker 2930, a route identifier 2940, and a notification manager 2960, which execute on the device 2905.

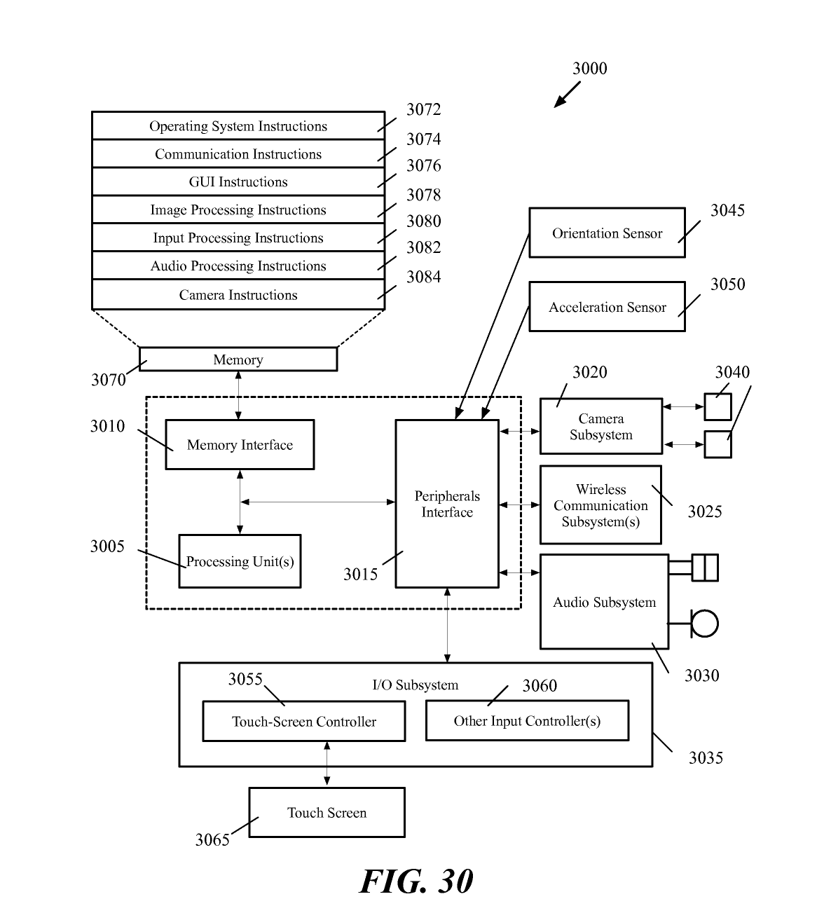

In some embodiments, the device 2905 is a mobile device, such as a smartphone, a tablet computer, and a laptop computer. The device 2905 also facilitates the interaction between the calendar application and other applications (not shown) executed on the device or other devices and between the calendar application and remote servers. This figure does not depict all of the modules of the device for the simplicity of description and illustration. More details about an example of a device on which the navigation application may execute will be described further below by reference to FIG. 30.

For the calendar application 2900, the appointment manager 2910 manages the appointments in the calendar. For instance, the appointment manager 2910 creates, modifies and deletes appointments based on user inputs or appointment requests received from the calendar application instances running on other devices. The appointment manager 2910 also supplies details about the appointments to other components of the calendar application 2900, such as the calendar layout manager 2945, the appointment location predictor 2920, and the reminders manager 2975.

The travel time manager 2915 manages the travel time items for the appointments in the calendar. For instance, the travel time manager 2915 creates, modifies and deletes travel time items based on user inputs or other information obtained from the other components of the calendar application 2900 and other modules executing in the device 2900. In some embodiments, the travel time manager 2915 performs all or part of the process 2500 to compute and/or update travel time items. The travel time manager 2915 also obtains the user's preferences on travel time items. For instance, in some embodiments, the travel time manager 2915 use the default mode of transportation for computing travel times, the default start location, the placement of travel times before and/or after appointments from the user's preferences.

The appointment location predictor 2910 identifies a location before an appointment or a location after an appointment when such locations are not specified and the travel time before or after the appointment are being computed. The appointment location predictor 2910 of some embodiments performs the process 1500 to identify such locations. That is, the appointment location predictor 2910 determines whether the location for a prior appointment is within a predefined distance from the location of the appointment, whether the location information for the user (i.e., the device) is available, or whether the locations are determinable based on certain heuristics. The appointment location predictor 2920 obtains information about the appointments from the appointment manager 2910 or through the travel time manager 2915. The appointment location predictor 2910 supplies the identified location(s) to the travel time manager 2915 so that the travel time manager 2915 can request routes between the identified locations from the route identifier 2940.

The transportation mode identifier 2935 identifies a mode of transportation for computing the travel time between two locations. In some embodiments, the transportation mode identifier 2935 performs the process 1800 to select or identify a mode of transportation. That is, the transportation mode identifier 2935 examines the appointment and/or the user's preferences to identify a pre-selected mode of transportation and determines whether the length of a given route is under or over a threshold value. The transportation mode identifier 2935 supplies the identified mode of transportation to the travel time manager 2915 and the route identifier 2940.

The calendar layout manager 2945 displays representations for the appointments along with representations for the associated travel times. The calendar layout manager 2945 receives appointment and travel time information from the appointment manager 2945 and the travel time manager 2915 and creates representations for the travel times and the appointments in various different calendar layouts as described above.

The reminders manager 2975 generates reminders for the appointments. The reminders manager 2975 obtains information about the appointments from the appointment manager 2910 and generates reminders for the appointments to present to the user. The reminders manager 2975 also communicates with the travel time manager 2915 to offset the reminder for an appointment based on an associated travel time for the appointment as discussed above by reference to FIG. 24.

The current location tracker 2930, the route identifier 2940, and the notification manager 2960 are modules executed on the device 2905. The calendar application 2900, specifically the travel time manager 2915, communicates with these modules to obtain information that are needed in managing the travel time items. These modules may be stand-alone applications executing on the device 2905 or part of applications executing on the device 2905.

The current location tracker 2930 tracks the current location of the user carrying the device on which the calendar application 2900 executes. In some embodiments, the current location tracker 2930 communicates with a GPS receiver (not shown) of the device that supplies a set of GPS coordinates to the current location tracker 2930. In some of these embodiments, the current location tracker augments the GPS data with other terrestrial tracking data, such as triangulated cellular tower data, triangulated radio tower data, and correlations to known access points (e.g., cell-ID, Wi-Fi ID/network ID), in order to improve the accuracy of the identified location. In addition, some embodiments use one or more of the types of terrestrial tracking data without GPS data. The current location tracker 2930 in some embodiments periodically supplies the current location information to the travel time manager 2915.

The route identifier 2940 identifies a set of routes between a start location to a destination location for one or more modes of transportation. In some embodiments, the route identifier uses a local route generation engine (not shown) of the device to obtain the routes. Alternatively or conjunctively, the route identifier communicates with a remote route generation engine (not shown) to obtain the routes. In some embodiments, the route identifier provides information about the start location, destination location, and mode of transportation to the route generation engines. In some such embodiments, the route generation engines may return travel times along with the generated routes to the route identifier 2940. From the generated travel time, the route identifier can estimate the traffic level along a route. Alternatively, the route identifier receives explicit traffic data from the route generation engine in some embodiments. When the route has been specified before, the route generation engine of some embodiments only provides travel times and/or traffic data in some embodiments. The route and traffic identification process of some embodiments is further described in U.S. Provisional Patent Application 61/832,853 and in the concurrently filed U.S. patent application Ser. No. ______ entitled “Warning for Frequently Traveled Trips Based on Traffic” with the attorney docket number APLE.P0571. U.S. Provisional Patent Application 61/832,853 and the concurrently filed U.S. patent application with the attorney docket number APLE.P0571 are incorporated herein by reference.

The notification manager 2960 manages the notifications to the user. In some embodiments, the notification manager 2960 performs part of the process 2500 to present alerts to the user. In some embodiments, the notification manager 2960 maintains the travel time for a given appointment received from the travel time manager 2915 and determines whether an updated travel time is significantly increased.

### VI. Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger application while remaining distinct software inventions. In some embodiments, multiple software inventions can also be implemented as separate applications. Finally, any combination of separate applications that together implement a software invention described here is within the scope of the invention. In some embodiments, the software applications, when installed to operate on one or more electronic systems, define one or more specific machine implementations that execute and perform the operations of the software applications.

A. Mobile Device

The mapping and navigation applications of some embodiments operate on mobile devices, such as smart phones (e.g., iPhones®) and tablets (e.g., iPads®). FIG. 30 is an example of an architecture 3000 of such a mobile computing device. Examples of mobile computing devices include smartphones, tablets, laptops, etc. As shown, the mobile computing device 3000 includes one or more processing units 3005, a memory interface 3010 and a peripherals interface 3015.

The peripherals interface 3015 is coupled to various sensors and subsystems, including a camera subsystem 3020, a wireless communication subsystem(s) 3025, an audio subsystem 3030, an I/O subsystem 3035, etc. The peripherals interface 3015 enables communication between the processing units 3005 and various peripherals. For example, an orientation sensor 3045 (e.g., a gyroscope) and an acceleration sensor 3050 (e.g., an accelerometer) is coupled to the peripherals interface 3015 to facilitate orientation and acceleration functions.

The camera subsystem 3020 is coupled to one or more optical sensors 3040 (e.g., a charged coupled device (CCD) optical sensor, a complementary metal-oxide-semiconductor (CMOS) optical sensor, etc.). The camera subsystem 3020 coupled with the optical sensors 3040 facilitates camera functions, such as image and/or video data capturing. The wireless communication subsystem 3025 serves to facilitate communication functions. In some embodiments, the wireless communication subsystem 3025 includes radio frequency receivers and transmitters, and optical receivers and transmitters (not shown in FIG. 30). These receivers and transmitters of some embodiments are implemented to operate over one or more communication networks such as a GSM network, a Wi-Fi network, a Bluetooth network, etc. The audio subsystem 3030 is coupled to a speaker to output audio (e.g., to output voice navigation instructions). Additionally, the audio subsystem 3030 is coupled to a microphone to facilitate voice-enabled functions, such as voice recognition (e.g., for searching), digital recording, etc.

The I/O subsystem 3035 involves the transfer between input/output peripheral devices, such as a display, a touch screen, etc., and the data bus of the processing units 3005 through the peripherals interface 3015. The I/O subsystem 3035 includes a touch-screen controller 3055 and other input controllers 3060 to facilitate the transfer between input/output peripheral devices and the data bus of the processing units 3005. As shown, the touch-screen controller 3055 is coupled to a touch screen 3065. The touch-screen controller 3055 detects contact and movement on the touch screen 3065 using any of multiple touch sensitivity technologies. The other input controllers 3060 are coupled to other input/control devices, such as one or more buttons. Some embodiments include a near-touch sensitive screen and a corresponding controller that can detect near-touch interactions instead of or in addition to touch interactions.

The memory interface 3010 is coupled to memory 3070. In some embodiments, the memory 3070 includes volatile memory (e.g., high-speed random access memory), non-volatile memory (e.g., flash memory), a combination of volatile and non-volatile memory, and/or any other type of memory. As illustrated in FIG. 30, the memory 3070 stores an operating system (OS) 3072. The OS 3072 includes instructions for handling basic system services and for performing hardware dependent tasks.

The memory 3070 also includes communication instructions 3074 to facilitate communicating with one or more additional devices; graphical user interface instructions 3076 to facilitate graphic user interface processing; image processing instructions 3078 to facilitate image-related processing and functions; input processing instructions 3080 to facilitate input-related (e.g., touch input) processes and functions; audio processing instructions 3082 to facilitate audio-related processes and functions; and camera instructions 3084 to facilitate camera-related processes and functions. The instructions described above are merely exemplary and the memory 3070 includes additional and/or other instructions in some embodiments. For instance, the memory for a smartphone may include phone instructions to facilitate phone-related processes and functions. Additionally, the memory may include instructions for a mapping and navigation application as well as other applications. The above-identified instructions need not be implemented as separate software applications or modules. Various functions of the mobile computing device can be implemented in hardware and/or in software, including in one or more signal processing and/or application specific integrated circuits.

While the components illustrated in FIG. 30 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 30 may be split into two or more integrated circuits.

B. Computer System

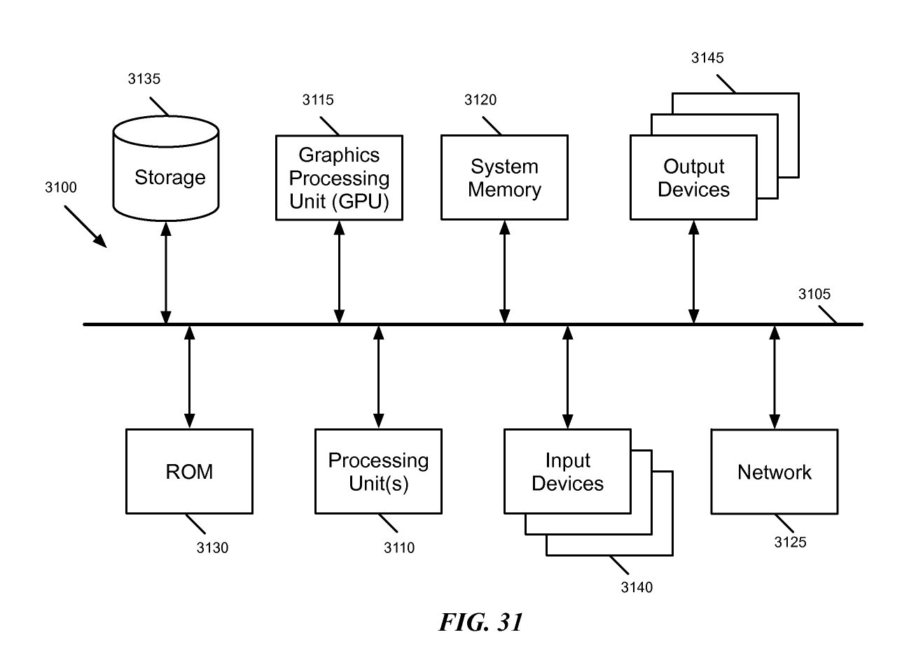

FIG. 31 conceptually illustrates another example of an electronic system 3100 with which some embodiments of the invention are implemented. The electronic system 3100 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 3100 includes a bus 3105, processing unit(s) 3110, a graphics processing unit (GPU) 3115, a system memory 3120, a network 3125, a read-only memory 3130, a permanent storage device 3135, input devices 3140, and output devices 3145.

The bus 3105 collectively represents all system, peripheral, and chipset buses that communicatively connect the numerous internal devices of the electronic system 3100. For instance, the bus 3105 communicatively connects the processing unit(s) 3110 with the read-only memory 3130, the GPU 3115, the system memory 3120, and the permanent storage device 3135.

From these various memory units, the processing unit(s) 3110 retrieves instructions to execute and data to process in order to execute the processes of the invention. The processing unit(s) may be a single processor or a multi-core processor in different embodiments. Some instructions are passed to and executed by the GPU 3115. The GPU 3115 can offload various computations or complement the image processing provided by the processing unit(s) 3110. In some embodiments, such functionality can be provided using Corelmage's kernel shading language.

The read-only-memory (ROM) 3130 stores static data and instructions that are needed by the processing unit(s) 3110 and other modules of the electronic system. The permanent storage device 3135, on the other hand, is a read-and-write memory device. This device is a non-volatile memory unit that stores instructions and data even when the electronic system 3100 is off. Some embodiments of the invention use a mass-storage device (such as a magnetic or optical disk and its corresponding disk drive, integrated flash memory) as the permanent storage device 3135.

Other embodiments use a removable storage device (such as a floppy disk, flash memory device, etc., and its corresponding drive) as the permanent storage device. Like the permanent storage device 3135, the system memory 3120 is a read-and-write memory device. However, unlike storage device 3135, the system memory 3120 is a volatile read-and-write memory, such a random access memory. The system memory 3120 stores some of the instructions and data that the processor needs at runtime. In some embodiments, the invention's processes are stored in the system memory 3120, the permanent storage device 3135, and/or the read-only memory 3130. From these various memory units, the processing unit(s) 3110 retrieves instructions to execute and data to process in order to execute the processes of some embodiments.

The bus 3105 also connects to the input and output devices 3140 and 3145. The input devices 3140 enable the user to communicate information and select commands to the electronic system. The input devices 3140 include alphanumeric keyboards and pointing devices (also called “cursor control devices”), cameras (e.g., webcams), microphones or similar devices for receiving voice commands, etc. The output devices 3145 display images generated by the electronic system or otherwise output data. The output devices 3145 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 31, bus 3105 also couples electronic system 3100 to a network 3125 through a network adapter (not shown). In this manner, the computer can be a part of a network of computers (such as a local area network (“LAN”), a wide area network (“WAN”), or an Intranet, or a network of networks, such as the Internet. Any or all components of electronic system 3100 may be used in conjunction with the invention.

Some embodiments include electronic components, such as microprocessors, storage and memory that store computer application instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer application that is executable by at least one processing unit and includes sets of instructions for performing various operations. Examples of computer applications or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

1. A non-transitory machine readable medium storing a calendar program, the program comprising a graphical user interface (“GUI”) comprising:
a display area for displaying a calendar layout for a period of time;
a set of representations of a set of appointments scheduled for the period of time; and
for at least one particular appointment, a representation of a travel time associated with the particular appointment.

2. The non-transitory machine readable medium of claim 1, wherein the GUI further comprises a tool for creating the travel time representation and specifying the travel time for the particular appointment.

3. The non-transitory machine readable medium of claim 2, wherein the tool comprises a selection area for selecting a travel time from a set of specified travel times.

4. The non-transitory machine readable medium of claim 3, wherein the selection area is further for allowing a user to manually enter the travel time.

5. The non-transitory machine readable medium of claim 2, wherein selection of the tool results in the execution of an automated process that calculates the travel time for the particular appointment without user input.

6. The non-transitory machine readable medium of claim 1, wherein the GUI further comprises a tool for selecting a method of travel and an automated process to calculate the travel time for the selected method of travel.

7. The non-transitory machine readable medium of claim 1,
wherein the representation of the travel time is a selectable user interface (UI) item;
wherein when the travel time representation is selected, a detailed view of the travel time is displayed, wherein the detailed view comprises at least one of a map of a route calculated for the travel time, directions for a route calculated for the travel time, and a tool for selecting a new travel time from a set of travel times to be represented by the travel time representation.

8-9. (canceled)

10. The non-transitory machine readable medium of claim 9, wherein the travel time is computed based on a location for the associated appointment, another location, and a method of travel, wherein the other location is one of a location of an event before the associated appointment or a location of an event after the associated appointment.

11. The non-transitory machine readable medium of claim 9, wherein the travel time is computed based on a location for the associated appointment, another location, and a method of travel, wherein the other location is not specified by a user but rather is generated by an automated process based on a set of heuristic rules.

12. The non-transitory machine readable medium of claim 9, wherein the travel time is computed based on a location for the associated appointment, another location, and a method of travel, wherein the representation of the travel time comprises at least one of a name for the other location, and a representation of the method of travel.

13. The non-transitory machine readable medium of claim 1, wherein the travel time for the particular appointment is a first travel time from a first location to a location for the appointment, the GUI further comprising a representation of a second travel time from the location for the appointment to a second location.

14. A non-transitory machine readable medium storing a calendar program, the program comprising sets of instructions for:
displaying a calendar layout for a period of time;
displaying a set of representations of a set of appointments scheduled for the period of time;
for a particular appointment, generating a set of travel times associated with the particular appointment; and
displaying at least one representation of a travel time of the set of travel times.

15. The non-transitory machine readable medium of claim 14, wherein the set of instructions for generating the set of travel times comprises sets of instructions for:
determining a set of travel time settings from a user's preferences; and
based on the set of travel time settings, automatically generating the set of travel times associated with the particular appointment.

16. The non-transitory machine readable medium of claim 14,
wherein the set of instructions for generating the set of travel times comprises a set of instructions for calculating a plurality of travel times based on a location for the particular appointment, another location, and a plurality of methods of travel;
wherein the set of instructions for calculating the plurality of travel times comprises a set of instructions for calculating a separate travel time for each travel method in the plurality of travel methods between the location for the particular appointment and the other location.

17. The non-transitory machine readable medium of claim 14,
wherein the set of instructions for generating the set of travel times comprises a set of instructions for calculating a plurality of travel times based on a location for the particular appointment, a plurality of secondary locations, and a method of travel;
wherein the set of instructions for calculating the plurality of travel times comprises a set of instructions for calculating a separate travel time between a location for the appointment and each secondary location in the plurality of secondary locations.

18. (canceled)

19. The non-transitory machine readable medium of claim 14, wherein the travel time represented by the representation is a first travel time, the program further comprises sets of instructions for:
retrieving a set of data which affects the first travel time of the particular appointment;
calculating a second travel time based on the set of data for the appointment; and
replacing the representation of the first travel time with a representation of the second travel time.

20. The non-transitory machine readable medium of claim 19, the program further comprising a set of instructions for, when the difference between the second travel time and the first travel time exceeds a threshold value, creating a notification to indicate that the travel time for the appointment has changed.

21. The non-transitory machine readable medium of claim 20, wherein the threshold value depends on an amount of time between a current time and a start time of the appointment.

22. The non-transitory machine readable medium of claim 19, wherein the data is traffic data and the set of instructions for calculating the second travel time comprises a set of instructions for determining an expected delay due to traffic between a location of the appointment and another location.

23. The non-transitory machine readable medium of claim 19, wherein the data is current location data and the set of instructions for calculating the second travel time comprises a set of instructions for determining a travel time from the current location to a location of the appointment.

24. The non-transitory machine readable medium of claim 14, wherein the set of instructions for generating the set of travel times comprises a set of instructions for calculating the travel time based on public transit time schedules.

25. The non-transitory machine readable medium of claim 14, wherein the set of instructions for generating the set of travel times comprises a set of instructions for identifying a travel method by:
determining a distance between the location of the appointment and the other location; and
when the distance is greater than a threshold distance, identifying a first travel method; and
when the distance is less than the threshold distance, identifying a second travel method.

26. The non-transitory machine readable medium of claim 25, wherein the threshold distance is based on at least one of user preferences and expected weather conditions.

27. (canceled)

28. A device comprising:
a display screen for displaying a calendar layout for a period of time;
at least one processing unit; and
a storage storing a calendar program, the program for execution by the processing unit, the program comprising sets of instructions for:
displaying a set of representations of a set of appointments scheduled for the period of time; and
for at least one particular appointment, generating a set of representations of travel times associated with the particular appointment.

29. The device of claim 28 further comprising a positioning module for determining a location for the device, wherein at least one representation of the set of representations of the set of appointments is modified based on the location for the device.

30. (canceled)
